(19) United States
(12) Patent Application Publication
(10) Pub. No.: US 2024/0354057 A1
(43) Pub. Date: Oct. 24, 2024

(54) PROCESSOR CIRCUITRY TO PERFORM A FUSED MULTIPLY-ADD

(71) Applicant: Intel Corporation, Santa Clara, CA (US)

(72) Inventors: Jongwook Sohn, Austin, TX (US); David Dean, Austin, TX (US); Eric Quintana, Austin, TX (US); Wing Shek Wong, Austin, TX (US)

(73) Assignee: Intel Corporation, Santa Clara, CA (US)

(21) Appl. No.: 18/523,186

(22) Filed: Nov. 29, 2023

Related U.S. Application Data
(60) Provisional application No. 63/460,393, filed on Apr. 19, 2023.

(51) Int. Cl. G06F 7/523

(52) U.S. Cl. CPC G06F 7/523

(57) ABSTRACT

Techniques and mechanisms for circuitry to support the performance of a fused multiply-add (FMA) operation with one or more denormal numbers. In some embodiments, a processor is operable to execute a FMA instruction comprising or otherwise identifying two multiplicands, and an addend. Such execution includes performing one-way alignment of an addend significand based on a difference between respective exponent values of the two multiplicands. The alignment is performed in parallel with operations by a multiplier circuit based on respective significand values of the two multiplicands. Subtraction of a J-bit correction value is performed in the multiplier circuit to avoid mitigate execution delay. In another embodiment, first circuitry of a processor executes an FMA instruction, wherein components of the first circuitry are shared with second circuitry of the processor, and wherein the second circuitry supports the execution of a floating-point multiplication instruction.

### CLAIM OF PRIORITY

The present application claims priority under 35 U.S.C. § 119 (e) to U.S. Provisional Patent Application Ser. No. 63/460,393 filed Apr. 19, 2023 and entitled “PROCESSOR CIRCUITRY TO PERFORM A FUSED MULTIPLY-ADD,” which is herein incorporated by reference in its entirety.

### BACKGROUND

### 1. Technical Field

This disclosure generally relates to processor operations and more particularly, but not exclusively, to the execution of a fused multiply-add instruction.

### 2. Background Art

Various existing processor core architectures do not have a capability of computing fused multiply-add (FMA) with denormal numbers in its floating-point hardware. To handle the denormal numbers, microcode assistance is usually needed. However, use of a microcode exception handler requires a multi-cycle delay, which tends to degrade the performance.

Since handling denormal numbers requires more complex processes, traditional floating-point units only deal with normal numbers. In this case, a microcode exception handler is required to compute the denormal numbers, which takes cycles of additional delay and significantly degrades the performance. As successive generations of processor architectures continue to increase in number, variety, and capability, there is expected to be an increasing premium placed on improvements to the processing of denormal numbers.

### BRIEF DESCRIPTION OF THE DRAWINGS

The various embodiments of the present invention are illustrated by way of example, and not by way of limitation, in the figures of the accompanying drawings and in which:

FIGS. 1A, 1B are hybrid circuit-block diagrams each illustrating respective portions of circuitry to execute a fused multiply-add instruction according to an embodiment.

FIG. 2 is a hybrid circuit-block diagram illustrating features of circuitry to detect a difference between exponent values according to an embodiment.

FIG. 3 is a hybrid circuit-block diagram illustrating features of circuitry to determine an exponent value of a fused multiply-add calculation according to an embodiment.

FIG. 4 is a circuit diagram illustrating features of circuitry to align bits of a significand value according to an embodiment.

FIG. 5 is a data diagram illustrating respective scenarios each to align a significand value according to a corresponding embodiment.

FIG. 6 is a circuit diagram illustrating features of a circuit to determine a partial product in a fused multiply-add calculation according to an embodiment.

FIG. 7 is a circuit diagram illustrating features of a multiplier circuit to facilitate a fused multiply-add calculation according to an embodiment.

FIG. 8 is a circuit diagram illustrating features of an adder circuit to facilitate a fused multiply-add calculation according to an embodiment.

FIGS. 9A-9D are circuit diagrams illustrating features of respective circuits each to anticipate a number of leading zeros in a value according to a corresponding embodiment.

FIG. 10 is a circuit diagram illustrating features of a normalization circuit to facilitate a fused multiply-add calculation according to an embodiment.

FIG. 11 is a circuit diagram illustrating features of a processor to execute either of a fused multiply-add instruction or a floating-point multiplication instruction according to an embodiment.

FIG. 12 illustrates examples of hardware to process an instruction such as a fused multiply-add instruction according to an embodiment.

FIG. 13 illustrates examples of a method to process a fused multiply-add instruction according to an embodiment.

FIG. 14 illustrates an example method to process a fused multiply-add instruction using emulation or binary translation according to at least one embodiment.

FIG. 15 illustrates an exemplary system.

FIG. 16 illustrates a block diagram of an example processor that may have more than one core and an integrated memory controller.

FIG. 17A is a block diagram illustrating both an exemplary in-order pipeline and an exemplary register renaming, out-of-order issue/execution pipeline according to examples.

FIG. 17B is a block diagram illustrating both an exemplary example of an in-order architecture core and an exemplary register renaming, out-of-order issue/execution architecture core to be included in a processor according to examples.

FIG. 18 is a block diagram illustrating the use of a software instruction converter to convert binary instructions in a source instruction set architecture to binary instructions in a target instruction set architecture according to examples.

### DETAILED DESCRIPTION

Embodiments described herein variously provide techniques and mechanisms for supporting the performance of a fused multiply-add (FMA) operation on denormal numbers. In some embodiments, a processor is operable to perform a FMA without the requirement of a delay to access information which, according to conventional techniques, would otherwise be provided by microcode.

Certain features of various embodiments are described herein with reference to a 4-cycle performance of an FMA calculation, with full denormal support, by applying any of various suitable combinations of several improved features including (but not limited to):
1. one-way alignment,
2. radix-16 Booth encoding for a multiplier,
3. merged J-bit correction and aligned significand with a multiply array,
4. modified leading zero anticipation (LZA) for masking an underflow,
5. parallel sticky and all-ones detection with the normalization, and
6. merged two's complement with the rounding logic.

Some example embodiments variously operate on three 128-bit floating-point numbers (i.e., four 32-bit single precision values, or two 64-bit double precision values in each) and compute a multiplication followed by the addition or subtraction—e.g., according to the following:

$$x = ( A \cdot B ) \pm C .$$

By way of illustration and not limitation, some embodiments variously support execution of an FMA operation which takes place in 4 cycles, is fully pipelined, and/or is based on an instruction from any of various suitable instruction set architectures (or from an extension to such an instruction set architecture). In one such embodiment, the FMA operation is performed in the execution of an instruction from an Advanced Vector Extension (AVX) to an Intel x86 instruction set architecture, a Streaming Single Instruction, Multiple Data (SIMD) Extension (or “SSE”) to an Intel x86 instruction set architecture, or the like. Additionally or alternatively, the FMA operation is performed for any of scalar/packed single precision data or double precision data. Additionally or alternatively, circuitry to executed an FMA instruction supports all four rounding modes as specified in any of various IEEE-754 standards from the Institute of Electrical and Electronics Engineers (IEEE), such as the IEEE 754-2019 standard published in July 2019. Some embodiments fully support denormal operands with little (if any) additional delay, making microcode assistance unnecessary.

In addition, some embodiments further support execution of a floating-point multiplication (FMUL) operation—e.g., in 3 cycles. In one such embodiment, the FMUL functionality does not support denormal numbers in 3 cycles, but instead uses at least a portion of an FMA execution path to handle denormal numbers in 4 cycles (e.g., so that microcode assistance is unnecessary). In various embodiments, to handle denormal numbers, the FMUL result at the third cycle is discarded, and one or more later processor operations are suspended or terminated—e.g., only where said one or more later operations are dependent on the FMUL result. Such discarding and suspending/terminating is referred to herein as a “virtual fault.”

Several embodiments variously implement or otherwise used some or all of the following to facilitate efficient (e.g., 4-cycle) FMA with full denormal support:
1. One-Way Alignment. One-way significand alignment is performed with the addend significand based on the exponent difference in parallel with the multiplier. The third significand is initially placed at the left of the product, then it is shifted right by the shift amount based on the exponent difference, which allows the one-way alignment with no redundant shifters. Also, the sticky logic is performed in parallel with the alignment, which is used for the rounding logic.
2. Radix-16 Booth Encoding For The Multiplier. Radix-16 Booth encoding is used for area and power reduction. Although the radix-16 Booth encoding usually requires the pre-computations for multiples, it produces about half the partial products compared to the radix-4 Booth encoding (14 vs. 27), which reduces a level of carry-save adders (CSAs) in the multiply array. As a result, the radix-16 Booth encoding spends a lot less area and power with about the same latency compared to the radix-4 encoding.
3. Merged J-Bit Correction And Aligned Significand With The Multiply Array. J-bit, an implicit one bit above the most significant bit (MSB) of the significand, of the third operand is detected in parallel with the first level of the exponent difference logic so that there is no delay penalty. The first and second operands, however, need to be directly passed to the multiplier, so the J-bit detection could delay the critical path. To avoid the delay, some embodiments assume the both J-bits are ones, then subtracts one J-bit correction line in the multiply array, which requires a more partial product line and a few bits for two's complement, but they are merged with the existing CSAs and there is no additional delay. Also, the aligned third significand is inserted into the CSA tree to eliminate the additional CSA at the end of the multiply array.
4. Modified LZA For Masking The Underflow. Leading zero anticipation (LZA) is applied to speed up the normalization. The LZA is performed in parallel with the main adder so that the normalization is performed right after the main adder. Also, the LZA is modified to mask the underflow when the exponent is negative after the normalization. The modified LZA stops the normalization shifting when the exponent becomes zero so that the denormalization shifting is unnecessary, which significantly reduce the latency.
5. Parallel Sticky And All-Ones Detection With The Normalization. The sticky and all-ones detection logic is performed in parallel with the normalization to speed up the rounding logic. The detection logic allows the early roundup decision so that it is directly passed to the incrementor for the rounding.
6. Merged Two's Complement With The Rounding Logic. Two's complement for the main adder is merged with the rounding logic to avoid an additional MUX after the main adder. The two's complement is propagated to the rounding logic and forces the roundup of the significand result.
   Some embodiments perform a one-way significand alignment shift with the third significand based on the exponent difference. Simultaneously, the multiplier is performed with the first and second significands. The aligned third significand is merged with the multiply array to reduce the latency. The sum and carry values from the multiply array are passed to the main adder and incrementor. The LZA is performed in parallel with the main adder and it is used for normalization. The normalized significand is then rounded and passed to the last MUX to determine the special cases and precisions.

The technologies described herein may be implemented in one or more electronic devices. Non-limiting examples of electronic devices that may utilize the technologies described herein include any kind of mobile device and/or stationary device, such as cameras, cell phones, computer terminals, desktop computers, electronic readers, facsimile machines, kiosks, laptop computers, netbook computers, notebook computers, internet devices, payment terminals, personal digital assistants, media players and/or recorders, servers (e.g., blade server, rack mount server, combinations thereof, etc.), set-top boxes, smart phones, tablet personal computers, ultra-mobile personal computers, wired telephones, combinations thereof, and the like. More generally, the technologies described herein may be employed in any of a variety of electronic devices including circuitry to perform a FMA operation.

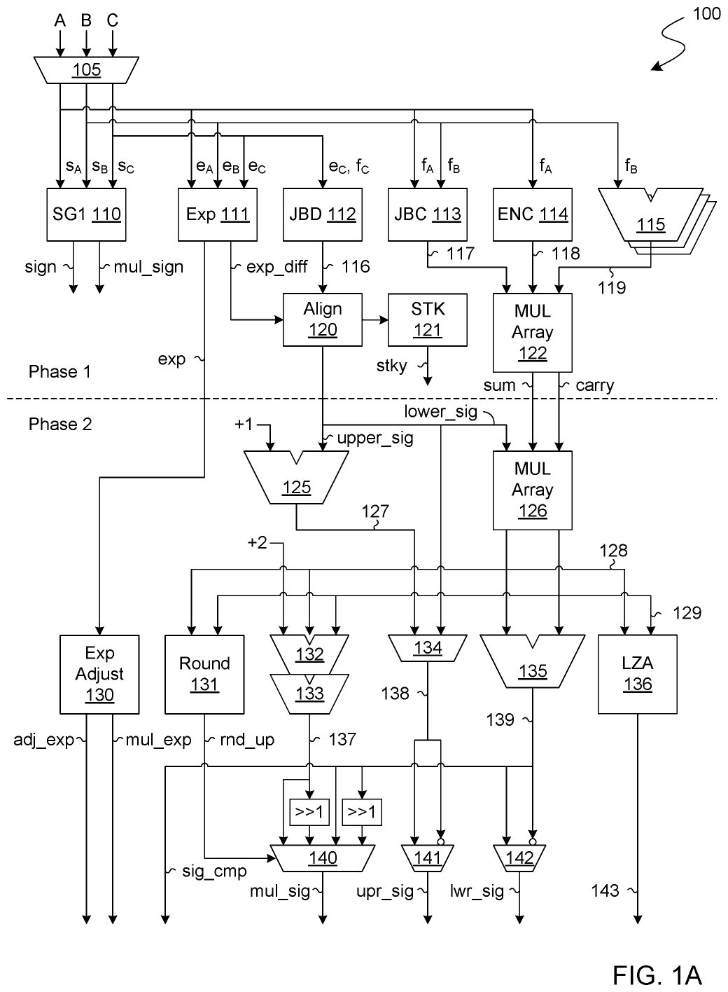

Some embodiments variously implement and/or use circuitry which facilitates efficient (e.g., 4-cycle) FMA execution that, for example, provides full denormalization support. FIG. 1A shows portions of circuitry 100 which is to perform, at least in part, an execution of a fused multiply-add (FMA) instruction that comprises a first operand A, a second operand B, and a third operand C. FIG. 1B shows a view 101 of other portions of circuitry 100. In an embodiment, circuitry 100 is provided with any of various single core or multi-core processors—e.g., such as any of various central processing units (CPUs), graphics processors, or the like. Alternatively, circuitry 100 is provided in any of various microcontrollers or other suitable processing-capable circuit devices.

To illustrate certain features of various embodiments, circuitry 100 is described herein with reference to an FMA operation based on 64-bit operands. In some embodiments, such a 64-bit operand can be represented, at least in part, with either of one double precision value, or two single precision values. However, some embodiments are not limited with respect to a particular size of such operands.

Certain features of various embodiments are described herein with respect to the execution of an FMA instruction over four phases (e.g., four consecutive cycles of a processor which includes circuitry 100). To illustrate such features, FIGS. 1A, 1B show, for each of various components of circuitry 100, a respective phase in which that component is contributing the FMA operation in question. However, other embodiments are not limited as to whether or how an FMA instruction might be executed within a particular number of cycles of a processor (or other suitable circuit device), or as to whether or how a given component of circuitry 100 might operate in a given cycle.

In one example embodiment, a first phase unit of circuitry 100 comprises circuitry to implement an exponent difference, alignment, encoding (e.g., Booth encoding), and a first part of a multiply array. Furthermore, a second phase unit of circuitry 100 comprises circuitry to implement the rest of the multiply array, a main adder, an incrementor and leading zero anticipation (LZA) logic. Further still, a normalization and rounding are performed with circuitry of a third phase unit of circuitry 100, and a fourth phase unit of circuitry 100 comprises circuitry to implement a last MUX and bypass/writeback logic.

In various embodiments, execution of a FMA instruction comprises circuitry 100 performing an operation which calculates a value x according to the following:

$$x = ( A \cdot B ) \pm C .$$

In an embodiment, the first operand A is a number which is represented by a first sign value s_{A}, a first exponent value e_{A}, and a first significand value f_{A}. Such a representation is referred to herein as a “denormalized representation,” or a “denormal representation.” An operand which is represented in such a way is sometimes referred to a “denormalized number,” a “denormal number,” or (for brevity) simply as a “denormal.”

Furthermore, the second operand B is a number which is represented by a second sign value s_{B}, a second exponent value e_{B}, and a second significand value f_{B}. Similarly, the third operand C is a number which is represented by a third sign value s_{C}, a third exponent value e_{C}, and a third significand value f_{C}.

Some embodiments perform a one-way significand shift to provide an alignment with the significand value f_{C}, based on a value (exp_diff) which indicates difference between two exponent values e_{A}, e_{B}. Simultaneously, a multiplier is performed with the significand values f_{A}, f_{B}. In one such embodiment, the aligned version of the third significand f_{C} is merged with the multiply array to reduce latency. The sum and carry values from the multiply array are passed to the main adder and incrementor. In some embodiments, the LZA is performed in parallel with the main adder, to facilitate efficient normalization of a product value which is based on significand values f_{A}, f_{B}. The normalized significand is then rounded and passed to the last MUX to account for any of various special cases and/or any of various levels of precision.

To facilitate execution of the FMA instruction, the respective values of operands A, B, C are variously distributed each to a respective one or more resources of circuitry 100—e.g., where such distributing is performed with the illustrative multiplex logic 105 shown (and/or with any of various other suitable circuit components).

Sign logic SG1 110 of circuitry 100 generates a signal (sign) which comprises one or more values, based on s_{A}, s_{B}, and s_{C}, to indicate at least in part whether a result of the FMA operation is to be positive or negative (i.e., greater than zero, or less than zero). The signal sign comprises a sign product value s_{M} and an effective sign value s_{Ceff} which, for example, are determined in a first phase (such as a first cycle of four consecutive processor cycles). For example, the values s_{M} and s_{Ceff} are calculated according to the following:

$${s}_{M} = {s}_{A} ⊕ {s}_{B} , and \\ {s}_{Ceff} = {s}_{C} ⊕ sub\_op ,$$

wherein sub_op is a value indicating whether or not the “±C” part of the FMA calculation is a minus (subtraction) operation.

Although some embodiments are not limited in this regard, sign logic SG1 110 further generates another signal (mul_sign) which comprises one or more values, based on s_{A}, s_{B} and s_{C}, indicating at least in part whether a result of a multiplication operation—e.g., a FMA operation or, alternatively, an FMUL operation to multiply floating point numbers—is to be positive or negative (i.e., greater than zero, or less than zero). In one such embodiment, mul_sign comprises s_{M}. (but, for example, omits s_{Ceff}, in some embodiments).

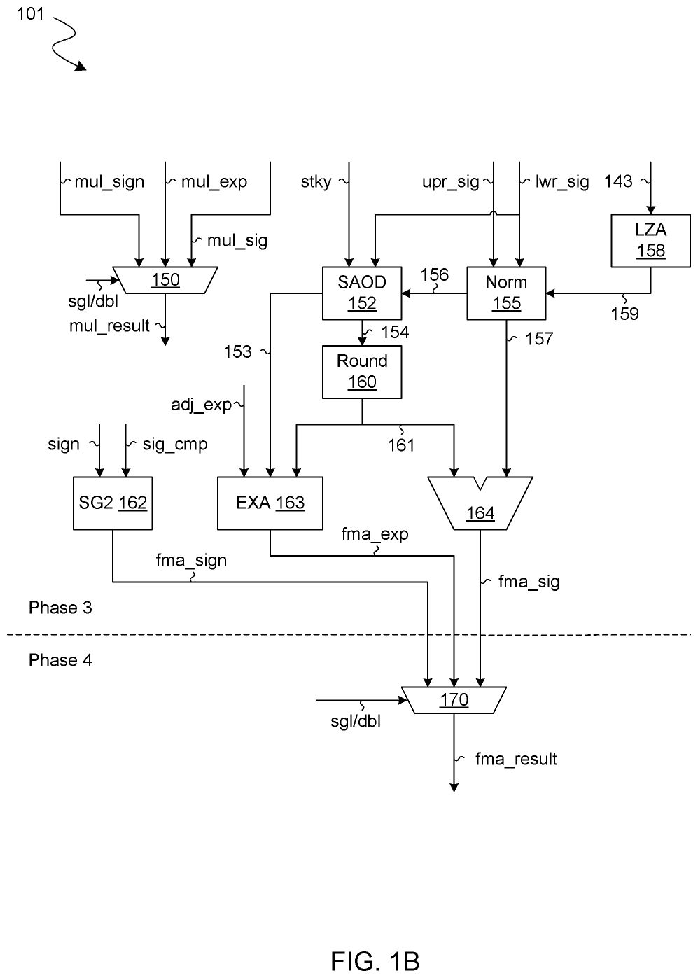

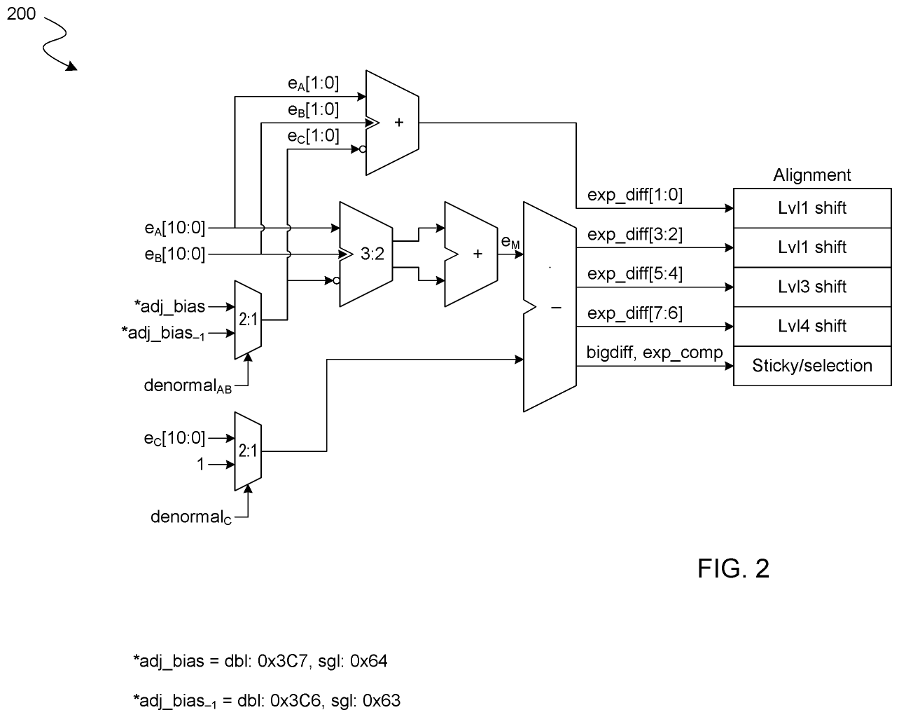

Exponent logic Exp 111 of circuitry 100 generates a signal (exp)-based on e_{A}, e_{B}, and e_{C}-which specifies or otherwise indicates an intermediate exponent value that is subject to being adjusted. Exponent logic Exp 111 further generates a signal (exp_diff)-based on e_{A}, e_{B}, and e_{C}-which specifies or otherwise indicates a difference between exponent values. Some example embodiments illustrating the generation of exp and exp_diff are described herein with reference to FIGS. 2 and 3.

J-bit detection logic JBD 112 of circuitry 100 generates a J-bit value (jbit_c) for operand C based on e_{C}. In an embodiment, the J-bit value (jbit_c) for operand C is determined by checking if e_{C} is zero—i.e., wherein jbit_c is to be equal to zero (“0”) if e_{C} is equal to zero, and where jbit_c is otherwise to be equal to one (“1”). The value jbit_c is passed, with f_{C}, are operand information 116 to align logic 120.

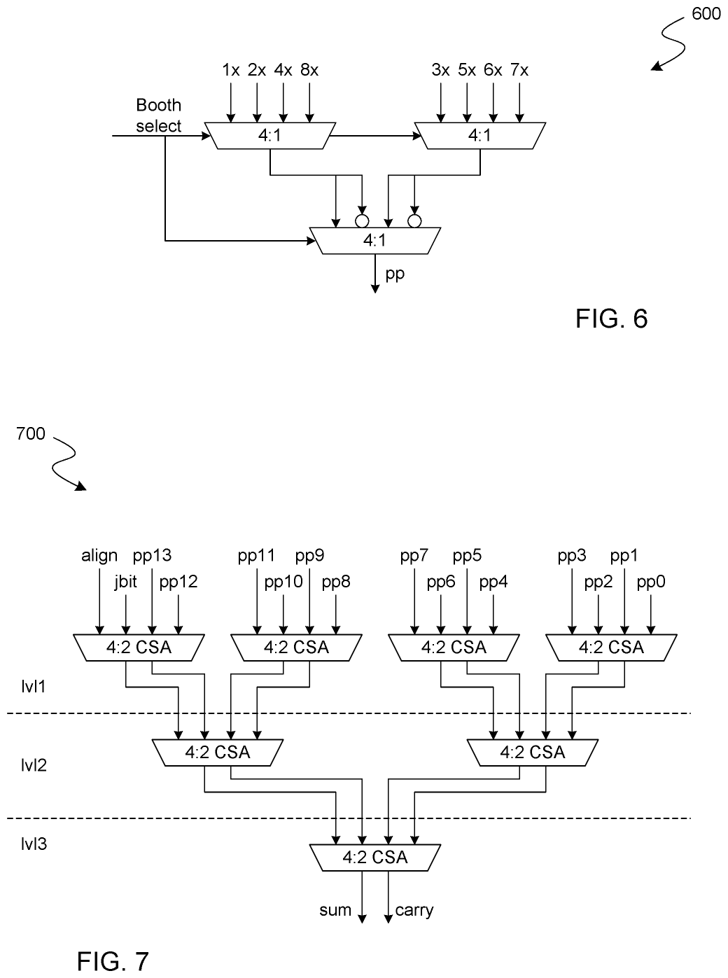

J-bit correction logic JBC 113 of circuitry 100 generates a correction value j_correct based on f_{A} and f_{B}. The value j_correct is provided as correction information 117 to a multiplier (MUL) array 122 of circuitry 100. As described herein with reference to FIG. 7, MUL array 122 will perform a subtraction based on the value j_correct. In one example embodiment, if operand A is denormal, then f_{B} is to be subtracted with MUL array 122. Alternatively, if operand B is denormal, then f_{A} is instead to be subtracted with MUL array 122. By contrast, no subtraction is performed (e.g., the value j_correct is equal to zero) if each of operands A, B is denormal.

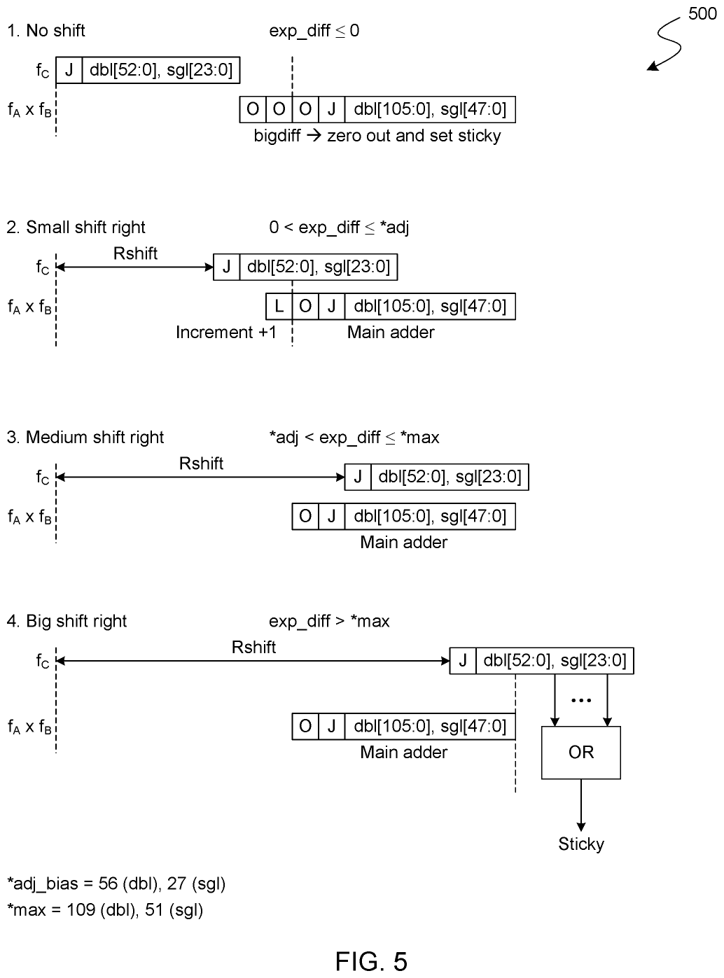

Encoder ENC 114 of circuitry 100 generates encoded information 118, based on f_{A}, which is used to select a particular multiple of f_{B}. For example, the significand f_{A} is encoded to determine a selection from among various multiples which are generated by computation logic 115. One example embodiment for the generation of encoded information 118 is described herein with reference to FIG. 6.

Computation logic 115 of circuitry 100 is coupled to generate various multiples (e.g., including a 1× multiple, a 2× multiple, a 3× multiple, etc.) of f_{B}. These multiples are communicated as values 119 to a MUL array 122 of circuitry 100, which will select one such multiple based on the encoded information 118.

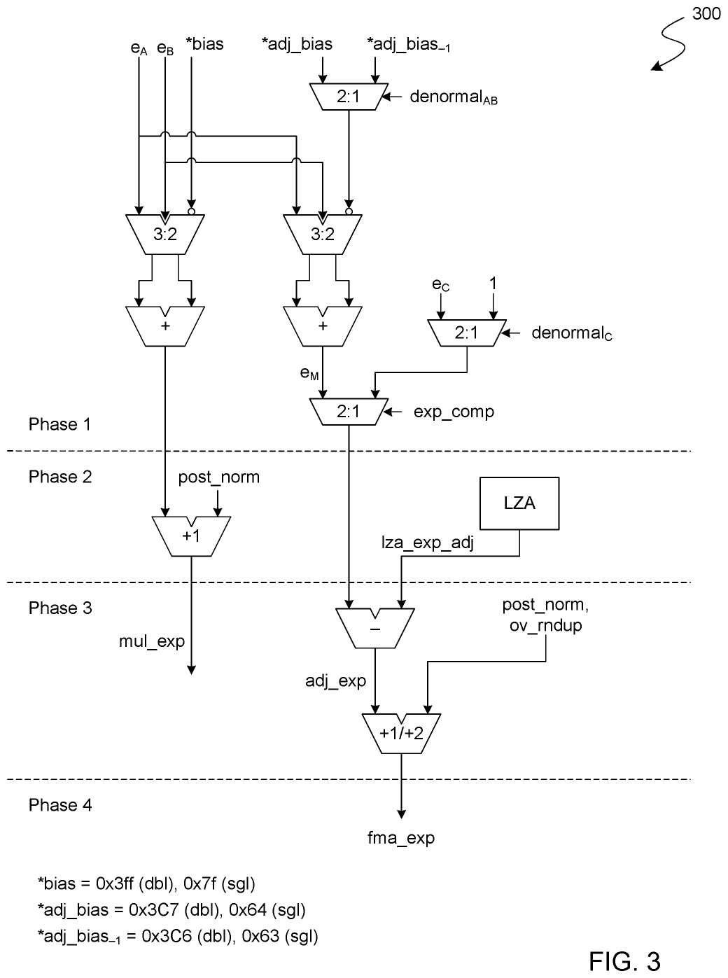

Align logic 120 of circuitry 100 receives operand information 116, and—based thereon-generates a version of f_{C} which has been shifted and/or otherwise modified to be aligned for addition to a product of operands A, and B. The aligned version of f_{C} is divided into relatively more significant bits (upper_sig), and relatively less significant bits (lower_sig). An adder 125 of circuitry 100 receives upper_sig, and increments it (in this example, by 1), to generate a signal 127. One example embodiment for the generation of upper_sig and lower_sig is described herein with reference to FIG. 4.

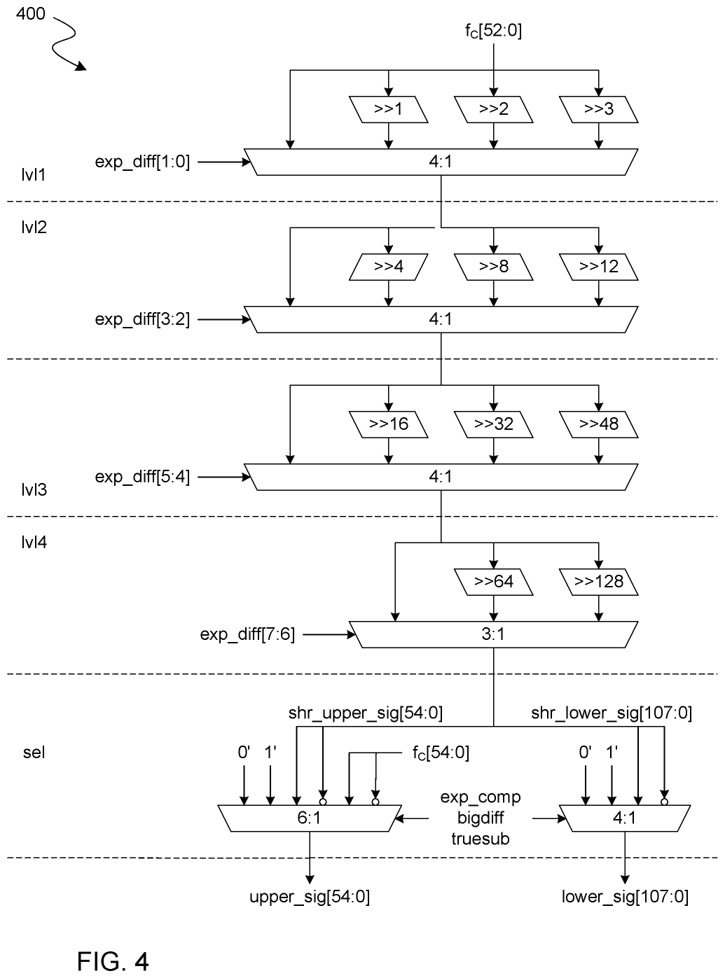

Sticky detection logic 121 of circuitry 100 determines the value of a sticky bit (stky) based on an output from align logic 120. In an embodiment, the bit stky is set (e.g., to one) only in certain cases which are illustrated in FIG. 5.

MUL array 122 of circuitry 100 generates an intermediate sum value and an intermediate carry value based on j_correct, encoded information 118, and the values 119. One example embodiment for the generation of encoded information 118 is described herein with reference to FIGS. 6 and 7.

Exponent adjust logic EXA 130 of circuitry 100 generates a signal (adj_exp), based on exp, which indicates at least in part an adjustment to be made to an exponent value for the calculation of a FMA result. Although some embodiments are not limited in this regard, exponent adjust logic EXA 130 further generates another signal (mul_exp), based on e_{A} and e_{B}, which indicates at least in part an exponent value for the calculation of a FMA/FMUL result. In one such embodiment, exponent adjust logic EXA 130 generates one or both of the signals adj_exp and mul_exp in a second phase of operations by circuitry 100 (such as a second cycle of the four consecutive processor cycles). One example embodiment for the generation of signals adj_exp and mul_exp is described herein with reference to FIG. 3.

Another MUL array 126 of circuitry 100 generates a secondary sum value 128, and a secondary carry value 129, based on lower_sig, the intermediate sum value, and the intermediate carry value. Some example features for the generation of the sum 128 and the carry 129 is described herein with reference to FIGS. 4 and 5.

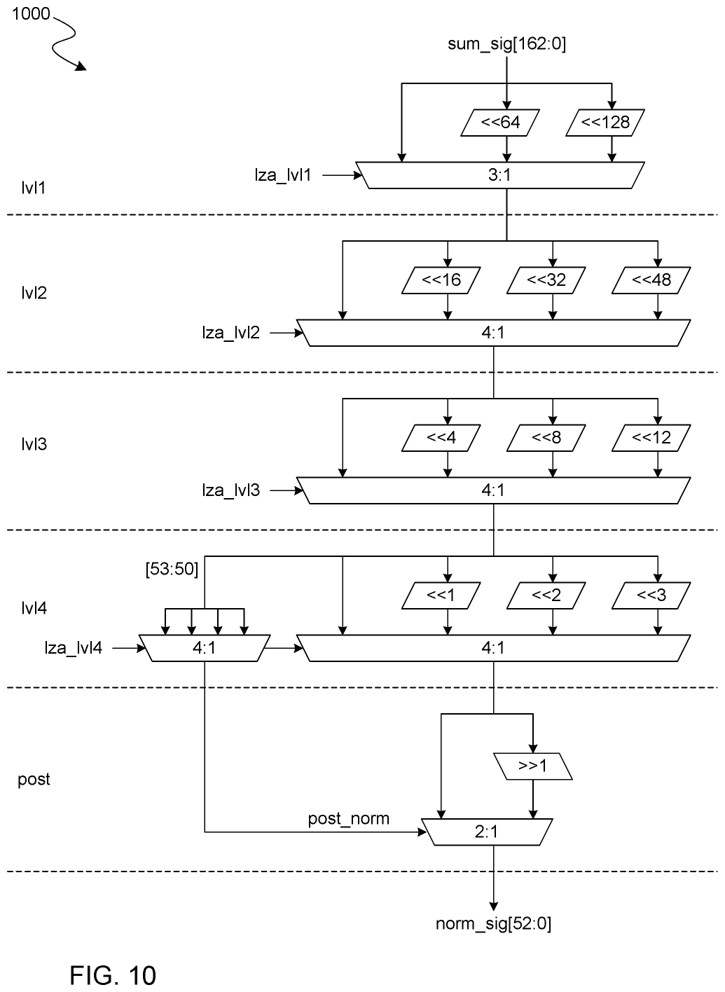

Although some embodiments are not limited in this regard, round logic 131 of circuitry 100 generates a signal (rnd_up), based on the sum 128 and the carry 129, which indicates a rounding to be applied for the calculation of a FMA/FMUL result. For example, rnd_up is based on, indicates, or otherwise implements any of various types of rounding including (for example) round toward 0, round toward +∞, round toward −∞, round to nearest (even), or the like. By way of illustration and not limitation, rnd_up facilitates rounding according to one of the four rounding modes indicated by the IEEE-754-2008 Standard. One example embodiment for the generation of rnd_up is described herein with reference to FIG. 11.

A combination of a carry-sum adder 132 and another adder 133 of circuitry 100 generates a signal 137 based on the sum 128, the carry 129, and +2 increment value. An example of features for the generation of signal 137 is described herein with reference to FIG. 11.

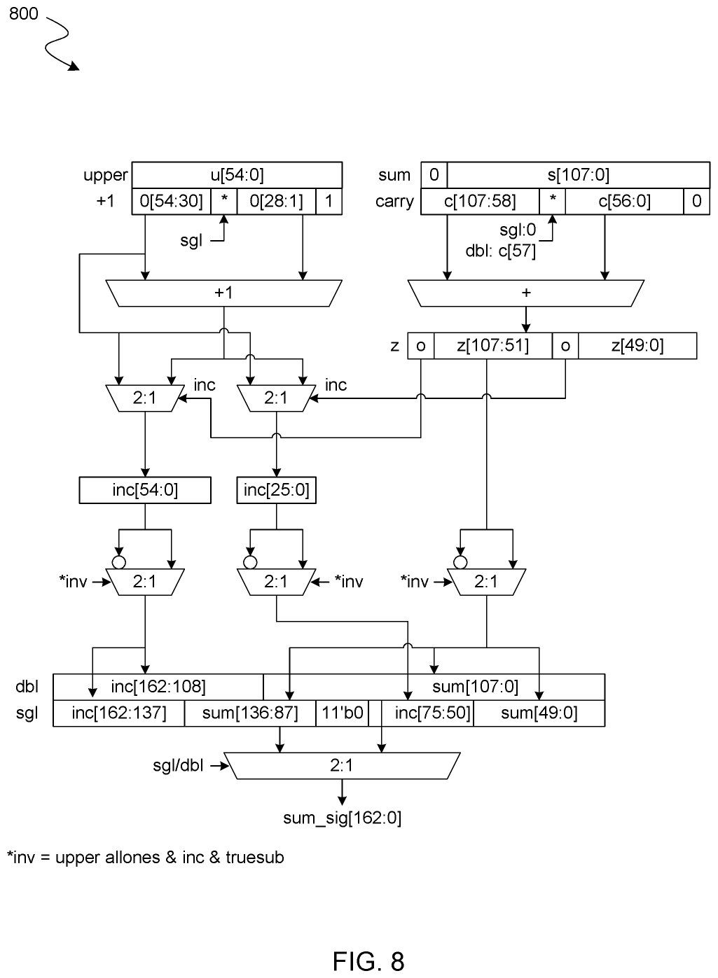

A multiplexer (MUX) 134 of circuitry 100 generates a signal 138 based on upper_sig and signal 127. Furthermore, another adder 135 of circuitry 100 generates a signal 139 output based on the sum 128 and the carry 129. Further still, another multiplexer (MUX) 141 of circuitry 100 provides, based on the signal 138, relatively more significant bits (upr_sig) of a significand value which is subsequently to be subject to normalization. By contrast, another multiplexer (MUX) 142 of circuitry 100 provides, based on signal 139, relatively less significant bits (lwr_sig) of that same significand value. An example of features for the generation of signals 138, 139, bits upr_sig, and bits lwr_sig is described herein with reference to FIG. 8.

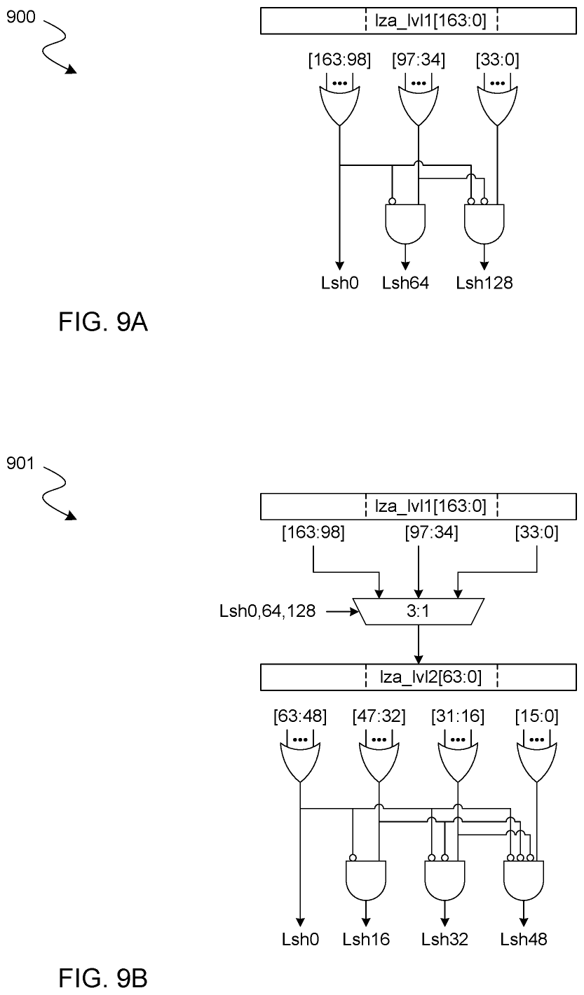

A leading zero anticipation (LZA) unit 136 of circuitry 100 generates a signal 143 based on the sum 128 and the carry 129. In an embodiment, signal 143 indicates and/or otherwise facilitates the prediction of a number of leading zeros in a value (such as that of sum 128, for example). Although some embodiments are not limited in this regard, another multiplexer (MUX) 140 of circuitry 100 provides a signal mul_sig, based on signal 137 and signal 139, which specifies or otherwise indicates a significand value for a result of a FMA/FMUL operation. One example embodiment for the generation of signal 143 and mul_sig is described herein with reference to FIGS. 9A-9D.

Referring now to FIG. 1B, sign logic SG2 162 of circuitry 100 generates a signal (fma_sign), based on sign and sig_comp, which indicates at least in part a sign value—e.g., positive or negative-which is to be part of a result of the FMA calculation. In an embodiment, sign logic SG2 162 generates fma_sign during a third phase of operations by circuitry 100 (e.g., a third cycle of the four consecutive processor cycles). In an embodiment, generation of fma_sign is based on whether an intermediate value of the FMA result is to be inverted (which is described herein with reference to FIG. 8). In one such embodiment, fma_sign is set to indicate negative if one of the following four cases (and set to indicate positive, otherwise):
(i) s_{M}=1, and s_{Ceff}=1,
(ii) s_{M}=1, and the rounding is not inverted
(iii) s_{Ceff}=1, and inverted
(iv) s_{M} ⊕s_{Ceff}=1, and round to-infinity

Although some embodiments are not limited in this regard, another multiplexer (MUX) 150 of circuitry 100 generates a signal (mul_result)-based on mul_sign, mul_exp, and mul_sig-which represents a result of a FMA/FMUL operation. In one such embodiment, multiplexing by MUX 150 is controlled based on a signal (sgl/dbl) which specifies or otherwise indicates whether an FMA/FMUL instruction being executed with circuitry 100 represents numbers in a single precision format, or a double precision format.

In an embodiment, another leading zero anticipation (LZA) unit 158 of circuitry 100 generates a signal 159 based on the signal 143. Signal 143 indicates and/or otherwise facilitates the prediction of a number of leading zeros in a value (such as that of sum 128, for example). One example embodiment for the generation of signal 159 is described herein with reference to FIGS. 9A-9D.

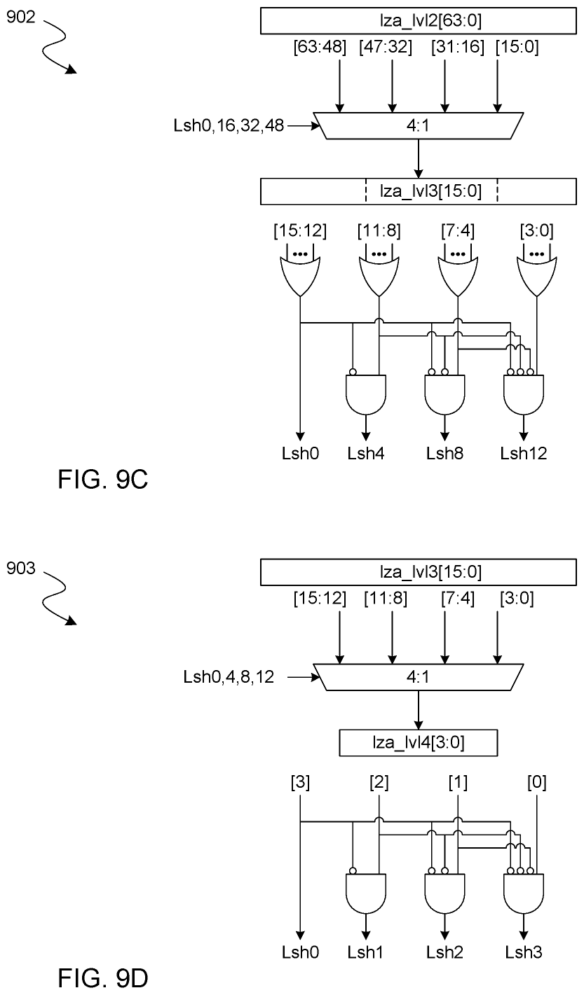

Normalization logic 155 of circuitry 100 generates a signal 156, and a norm_sig signal 157 based on upr_sig, lwr_sig, and the signal 159. The norm_sig signal 157 represents a normalized version of the significand value which comprises bits upr_sig and bits lwr_sig. Signal 156 comprises information, generated during the normalization, to facilitate sticky bit detection and/or all-one detection. As used herein, “all-one detection” refers to the determination of a value (referred to herein as an “all-ones” value) which identifies whether, for a given number, each bit under (i.e., less significant than) a reference bit of the given number is equal to one. In the particular context of some embodiments, the reference bit corresponds to a least significant bit of an original number—e.g., prior to an at least partial normalization which shifted the (previously) least significant bit to generate the given number. In one embodiment, signal 156 specifies or otherwise indicates respective sticky bits from each of multiple levels of normalization by normalization logic 155. Alternatively or in addition, signal 156 specifies or otherwise indicates respective all-one values from each of multiple levels of normalization by normalization logic 155. Some example features for the generation of signal 156, and norm_sig signal 157 is described herein with reference to FIG. 10.

Sticky and all-ones detect (SAOD) logic 152 of circuitry 100 variously generates signals 153, 154 each based on a respective one or more of stky, the bits lwr_sig, and the signal 156. In one embodiment, one or each of signals 153, 154 comprise a final all-one value which, for example, is generated by SAOD 152 ANDing the values (e.g., all one values) which are indicated by the bits lwr_sig. Additionally or alternatively, one or each of signals 153, 154 comprise a sticky bit value which, for example, is generated by SAOD 152 ORing the multiple sticky bits which are indicated by signal 156.

Round logic 160 of circuitry 100 generates, based on the signal 154, a signal 161 (round_up) which indicates a rounding, if any, to be performed on the normalized significand value which is represented by signal 157. One example embodiment for the generation of round_up signal 161 is described herein.

Another adder 164 of circuitry 100 generates a signal (fina_sig)-based on round_up signal 161, and norm_sig signal 157—including a significand value which is to be part of a result of the FMA operation. Furthermore, exponent adjust logic EXA 163 of circuitry 100 generates a signal (fina_exp)-based on adj_exp, signal 153, and signal 161—which comprises an exponent value which is to be part of the result of the FMA operation. One example embodiment for the generation of fina_exp is described herein with reference to FIG. 3.

Another multiplexer (MUX) 170 of circuitry 100 generates a result (fina_result) of the FMA calculation based on fina_sign, fina_exp, and fina_sig. In an embodiment, multiplexing by MUX 170 is based on the signal sgl/dbl—e.g., wherein the multiplexing is performed in a fourth phase of operations by circuitry 100 (such as a last one of the four consecutive processor cycles).

Certain resources of circuitry 100 (referred to herein collectively as the “main adder”) facilitate the calculation of a sum of operand C with a product of the operands A and B. In one such embodiment, the main adder comprises some or all of adder 125, adder 135, MUX 134, MUX 141, and MUX 142.

In various embodiments, some components of circuitry 100 are used in both the execution of a FMA instruction and the execution of a FMUL instruction. In one such embodiment, other components of circuitry 100 are used in the execution of only a FMA instruction—e.g., wherein still other components of circuitry 100 are used in the execution of only a FMUL instruction. In some embodiments, circuitry 100 facilitates the execution of a FMA instruction, but omits one or more components which are specific to the execution of a FMUL operation—e.g., wherein such one or more components comprise round logic 131, carry-sum adder 132, adder 133, MUX 140, and/or MUX 150.

FIG. 2 shows a circuit diagram illustrating features of exponent difference logic 200 which comprises circuitry to detect a difference between exponent values according to an embodiment. The exponent difference logic 200 includes features of exponent logic Exp 111, in some embodiments.

As shown in FIG. 2, exponent difference logic 200 determines a significand alignment shift amount. For example, an exponent difference is implemented by subtracting e_{C} from another value e_{M}. The value e_{M} is computed by adding e_{A} and e_{B}, then subtracting a value (bias), which, in one example embodiment, is 0x3ff for double precision and 0x7f for single precision, respectively. Since the third significand f_{C} is right shifted in one direction, it needs to be placed leftmost of the alignment bit range. To correct the gap between the addend and product significands, the e_{M} is adjusted by adding 56 for double and 27 for single precision, respectively. Thus, e_{M} is subtracted by the adjusted bias. The adjusted bias is subtracted by one if the first or second operand is denormal to handle the 1-bit denormal bias. Likewise, the e_{C} is adjusted to one if it is denormal.

Furthermore, another value (exp_comp) is determined by the MSB of the exponent difference, which is used for the significand selection after the alignment. In one example embodiment, the values are determined according to the following:

$${e}_{M} = {e}_{A} + {e}_{B} - adj\_bias \\ exp\_diff = {e}_{M} - {e}_{C} \qquad ( 1 )$$

$$and$$

$$exp\_comp = \{ \begin{matrix}1 & if {e}_{M} > {e}_{3} \\ 0 & otherwise\end{matrix} \qquad ( 2 )$$

In one illustrative embodiment, an exponent difference is computed in four levels, with 2 bits in each level—1^{st} level [1:0], 2^{nd} level [3:2], 3^{rd} level [5:4], and 4^{th} level [7:6]. The respective two bits in each level represent a shift amount of the significand alignment.

A 2-bit subtraction for the first level exponent difference is performed separately so that the first level significand alignment starts before the entire exponent difference is completed. Some embodiments further detect another value (bigdiff) which indicates whether the exponent difference is large enough to pose a risk that the significand bits would be shifted out. In this case, all the smaller significand bits are shifted out and the sticky bit stky is set. In an embodiment, the value bigdiff is determined according to the following:

$$bigdiff = \{ \begin{matrix}1 & if exp\_diff \leq 0 or exp\_diff \geq maxdiff \\ 0 & otherwise\end{matrix} \qquad ( 3 )$$

where (in one example embodiment) the maxdiff is 192 for double and 128 for single precision, respectively.

Some embodiments selectively multiplex between a first bias value (*adj_bias) and a second bias value (*adj_bias₋₁) based on a signal (denormal_{AB}) which indicates whether operand A or operand B is a denormal. In one such embodiment, *adj_bias is 0x3C7 in the case of double precision, and 0x64 in the case of single precision (e.g., wherein *adj_bias₋₁ is 0x3C6 in the case of double precision, or 0x63 in the case of single precision). Additional multiplexing is performed based on another signal (denormal_{C}) which indicates whether operand C is a denormal.

FIG. 3 shows a circuit diagram illustrating features of circuitry 300 to determine an exponent value of a FMA result according to an embodiment. The circuitry 300 shown in FIG. 3 includes features of exponent logic Exp 111, exponent adjust logic EXA 130, and/or exponent adjust logic EXA 163, in some embodiments.

As shown in FIG. 3, a sign value s_{M} for a FMUL calculation, and an “effective” sign value s_{Ceff} are determined—e.g., in a first cycle-according to the following:

$${s}_{M} = {s}_{A} ⊕ {s}_{B} \\ {s}_{Ceff} = {s}_{C} ⊕ sub\_op \qquad ( 4 )$$

In some embodiments, the sign of the FMA is determined in a third cycle, since it requires to check whether the result is inverted (which is described herein with reference to the main adder). In one such embodiment, the FMA sign is set to negative if one of the following four cases, and set to positive, otherwise.

$${s}_{M} = 1 and {s}_{Ceff} = 1 \\ {s}_{M} = 1 and not inverted \\ {s}_{Ceff} = 1 and inverted \\ {s}_{M} ⊕ {s}_{Ceff} = 1 and round to - infinity$$

The circuitry 300 further computes two exponent values—mul_exp and fmna_exp-which are to be available for (respectively) the case of a FMA calculation, and the case of a FMUL calculation.

The FMUL exponent is computed by adding e_{A} and e_{B}, and subtracting a bias, which is 0x3ff for double and 0x7f for single precision, respectively. Then, the resulting value is selectively adjusted by adding a post_norm value, which is one (“1”) if it is post-normalized (e.g., as described herein with respect to FMUL calculations).

$$mul\_exp = {e}_{A} + {e}_{B} - bias + post\_norm \qquad ( 5 )$$

The circuitry 300 computes e_{M} and e_{C} (as described herein with respect to FIG. 2) and selects one of them based on exp_comp. The selected exponent is adjusted by subtracting the normalization shift amount (as indicated by LZA circuitry). Then, it is adjusted again by adding one or two based on the post_norm and ov_rndup, which is described herein with respect to FIG. 10.

$$fma\_exp = \{ \begin{matrix}adj\_exp + 2 & if post\_norm \& ov\_rndup \\ adj\_exp + 1 & if post\_norm ⊕ ov\_rndup \\ adj\_exp & otherwise\end{matrix} \qquad ( 6 )$$

FIG. 4 shows a circuit diagram illustrating features of an alignment circuitry 400 to align bits of a significand value according to an embodiment. The alignment circuitry 400 includes features of align logic 120, in some embodiments. In some processing techniques, a J-bit is an implicit one for normal numbers. To handle denormal numbers, however, the J-bit needs to be treated as zero. In various embodiments, the J-bit of a number is determined by checking if the exponent is non-zero—e.g., wherein:

$$Jbit = \{ \begin{matrix}1 & if exp \neq 0 \\ 0 & otherwise\end{matrix} \qquad ( 7 )$$

In one such embodiment, the J-bit of the significand f_{C} is detected in parallel with the first level of the exponent difference so that there is no additional delay to handle denormal numbers. Then, said J-bit is right shifted based on the exponent difference.

As shown in FIG. 4, significand alignment comprises four levels of shifters and a subsequent selection multiplexing, as shown in FIG. 4. In each level, one of three or four shift amounts is selected based on the exponent difference-1^{st} level [0, 1, 2, or 3], 2^{nd} level [0, 4, 8, or 12], 3^{rd} level [0, 16, 32, or 48], and 4^{th} level [0, 64, or 128]. Subsequently, the aligned significand is split into the upper 55 bits and lower 108 bits.

In one such embodiment, the upper bits (upper_sig) of the aligned significand and the lower bits (lower_sig) of the aligned significand are determined based on bigdiff, exp_comp and truesub—e.g., according to a selection indicated in TABLE I and TABLE II below:

TABLE I
Upper Aligned Significand Selection

| bigdiff | exp_comp | truesub | upper_sig |
|---|---|---|---|
| 0 | — | 0 | aligned f_{c} |
| 0 | — | 1 | aligned and inverted f_{c} |
| 1 | 0 | 0 | f_{c} |
| 1 | 0 | 1 | inverted f_{c} |
| 1 | 1 | 0 | ′0 |
| 1 | 1 | 1 | ′1 |

TABLE II
Lower Aligned Significand Selection

| bigdiff | truesub | lower_sig |
|---|---|---|
| 0 | 0 | aligned f_{c} |
| 0 | 1 | aligned and inverted f_{c} |
| 1 | 0 | ′0 |
| 1 | 1 | ′1 |

In one embodiment, truesub is generated by XORing the three signs s_{A}, s_{B}, s_{C}, and the subtraction operation indicator sub_op—e.g., according to the following:

$$truesub = \{ \begin{matrix}1 & if {s}_{A} ⊕ {s}_{B} ⊕ {s}_{C} ⊕ sub\_op \\ 0 & otherwise\end{matrix} \qquad ( 8 )$$

The selected upper significand bits upper_sig are passed to the incrementor. Furthermore, the lower significand bits lower_sig are passed to the multiply array to be merged with the significand product, then passed to the main adder.

FIG. 5 shows a data diagram 500 illustrating various alignment scenarios each according to a respective embodiment. Some or all of the alignment scenarios are variously implemented, for example, with align logic 120. As shown in FIG. 5, there are four cases of alignment:
1) No shift is needed if the e_{C} is large enough so that all the product significand bits are shifted out and sticky bit stky is set.
2) A small right shift is needed if the e_{C} is smaller than e_{M} and some of the f_{C} bits are overlapped with the product bits, and the upper f_{C} bits are passed to the incrementor and the lower product bits are passed to the main adder.
3) A medium right shift is needed if the e_{C} is larger than the e_{M} and the f_{C} bits are completely overlapped with the product bits, and all those bits are passed to the main adder.
4) A big right shift is needed if the e_{C} is smaller than the e_{M} and some or all the f_{C} bits are shifted out below the LSB of the product, and those shifted bits are ORed to determine the sticky bit stky.

In some embodiments, the sticky logic is performed in parallel with the alignment. In one such embodiment, the sticky bit stky is set only in cases 1 and 4 of the alignment cases described above. In case 4, the sticky bit stky is set if the f_{C} is right shifted more than a maximum shift range. By way of illustration and not limitation, such a maximum shift range is between an upper 55 bits and a lower 109 bits (total 164 bits), in the double precision case. Additionally or alternatively, such a maximum shift range is between an upper 26 bits and a lower 51 bits (total 78 bits) in the single precision case.

FIG. 6 shows a circuit diagram illustrating features of multiplier circuitry 600 to determine partial product (pp) information according to an embodiment. The multiplier circuitry 600 includes features of MUL array 122, in some embodiments. FIG. 7 shows a circuit diagram illustrating features of a multiplier array 700 according to an embodiment. The multiplier array 700 includes features of MUL array 122 and/or MUL array 126, in some embodiments.

The significands f_{A}, f_{B} (and, for example, a jbit correction value) are passed to the multiplier—e.g., while the significand f_{C} is being aligned in the first cycle. Since the multiplier circuitry is on a critical path, some embodiments directly pass the significands f_{A}, f_{B} to the multiplier with minimal delay (if any) of the J-bit detection. To mitigate delay, some embodiments operate according to an initial assumption that the respective J-bits for operands A, and B are ones, then subtract one J-bit correction line in the multiply array 700 (e.g., adding one more partial product line and, for example, a few bits to support two's complement representation).

If the operand A is denormal, f_{B} is subtracted, and if the operand B is denormal, f_{A} subtracted—e.g., by providing the value to be subtracted in the J-bit correction line (jbit) shown. The case where both operands are denormal is ignored (i.e., no subtraction is performed), since it results in a tiny number with an underflow condition.

Some embodiments use encoding (e.g., a radix-16 Booth encoding) to reduce the area and power. Radix-16 Booth encoding produces about half the partial products compared to the radix-4 Booth encoding (14 vs. 27). The radix-16 Booth encoding, however, requires the precomputation to obtain 1×, 2×, . . . , and 8× multiples of the significand f_{B}, which needs three adders in parallel. Such precomputing is performed—e.g., by computation logic 115—to provide to the multiplex circuitry in FIG. 6 the following multiples:

$$1 x = {f}_{B} \\ 2 x = {f}_{B} << 1 \\ 3 x = 1 x + 2 x ( need an adder ) \\ 4 x = {f}_{B} << 2 \\ 5 x = 1 x + 4 x ( need an adder ) \\ 6 x = 3 {f}_{B} << 1 \\ 7 x = 8 x - 1 x ( need an adder ) \\ 8 x = {f}_{B} << 3$$

The significand f_{A} is encoded to select from among the precomputed multiples (and their respective inverted values). For example, the significand f_{A} is encoded—e.g., by encoder ENC 114—to generate a “Booth select” signal shown in FIG. 6. In one example embodiment, such encoding is performed to implement a selection scheme such as that shown in the Table III below:

TABLE III
Partial Product Selection Scheme

| Multiplier bits | Selection |
|---|---|
| 00000 | +0 |
| 00001 | +Multiplicand |
| 00010 | +Multiplicand |
| 00011 | +2 × Multiplicand |
| 00100 | +2 × Multiplicand |
| 00101 | +3 × Multiplicand |
| 00110 | +3 × Multiplicand |
| 00111 | +4 × Multiplicand |
| 01000 | +4 × Multiplicand |
| 01001 | +5 × Multiplicand |
| 01010 | +5 × Multiplicand |
| 01011 | +6 × Multiplicand |
| 01100 | +6 × Multiplicand |
| 01101 | +7 × Multiplicand |
| 01110 | +7 × Multiplicand |
| 01111 | +8 × Multiplicand |
| 10000 | −8 × Multiplicand |
| 10001 | −7 × Multiplicand |
| 10010 | −7 × Multiplicand |
| 10011 | −6 × Multiplicand |
| 10100 | −6 × Multiplicand |
| 10101 | −5 × Multiplicand |
| 10110 | −5 × Multiplicand |
| 10111 | −4 × Multiplicand |
| 11000 | −4 × Multiplicand |
| 11001 | −3 × Multiplicand |
| 11010 | −3 × Multiplicand |
| 11011 | −2 × Multiplicand |
| 11100 | −2 × Multiplicand |
| 11101 | −Multiplicand |
| 11110 | −Multiplicand |
| 11111 | −0 |

After the Booth encoding, multiple partial products (in this example, 14 partial products) are produced and provided to multiplier circuitry such as that illustrated by the CSA tree in FIG. 7. Furthermore, the J-bit correction line is provided to the CSA tree and becomes a 15th partial product value. Further still, an “align” input—which (for example) is the lower_sig bits generated by align logic 120—is provided to the CSA tree and becomes a 16th partial product value. In the example embodiment shown, the partial products are received by a CSA tree which (for example) comprises three levels of 4:2 CSAs. The CSA tree outputs a sum value, and a carry value, based on the received inputs.

In some embodiments, the 4:2 CSAs are modified to efficiently provide partial product reduction. In one such embodiment, one such 4:2 CSA comprises two back-to-back 3:2 CSAs, while it takes 3 XOR gate levels. Accordingly, the J-bit correction line (jbit) and aligned significand f_{C} bits (align) are added to the CSA tree without requiring an additional CSA level.

In various embodiments, partial products are grouped according to the number of partial products that need the same levels of CSAs to reduce the number of terms.
3-4 partial products (1 level of 4:2 CSA)
5-8 partial products (2 levels of 4:2 CSA)
9-16 partial products (3 levels of 4:2 CSA)

The sum and carry bits are produced, then passed to the main adder. In some embodiments, timing efficiency is facilitated by providing the first two levels of CSA tree in the first cycle unit, and a last level of CSA tree in the second cycle unit.

FIG. 8 shows a circuit diagram illustrating features of circuitry 800 to provide main adder and incrementor functionality according to an embodiment. The circuitry 800 shown in FIG. 8 includes features of adder 125, adder 135, round logic 131, MUX 141, and/or MUX 142, in some embodiments. As shown in FIG. 8, the significand sum and carry from the multiply array are passed to the main adder. The main adder computes the sum of the two significands for a set of double precision values—or alternatively, for two sets of single precision values—as shown in FIG. 8. Also, the upper significand from the alignment is passed to the incrementor.

The incrementor adds one to the upper significand only if the main adder results in a carry-out. In one example embodiment, the result of the main adder and incrementor needs to be two's complemented if it is positive. On the other hand, the result of the main adder and incrementor needs to be inverted if it is negative—e.g., wherein the result is converted according to the following:

$$X - Y = X + \overline{Y} + 1 ( X > Y ) \\ Y - X = \overline{X + \overline{Y}} ( X < Y ) \qquad ( 9 )$$

$$wherein Y - X = - ( X - Y ) = - ( X + \overline{Y} + 1 ) = - ( X + \overline{Y} ) - 1 = ( \overline{X + \overline{Y}} + 1 ) - 1 = \overline{X + \overline{Y}} ( X < Y ) .$$

As described herein, some embodiments variously merge the adding of a one (to obtain the two's complement value) with rounding operations to decrease the required time of one critical path. Inversion is detected by checking the carry-out of the incrementor. In some existing calculation circuits, incrementor operations would need to be delayed to accommodate such carry-out checking. To avoid such a delay, some embodiments variously detect for an instance of an inversion by checking if the upper significand bits are all ones, and by checking incremented (inc), and truesub—e.g., as follows:

$$inv = upper allones \& inc \& truesub$$

The inverted result of the main adder and incrementor is re-organized based on the precision, then passed to the third cycle unit for the normalization.

FIGS. 9A-9D show circuit diagrams illustrating respective features of a LZA circuit to anticipate a number of leading zeros in a value according to an embodiment. More particularly, the LZA circuit comprises successive levels 900, 901, 902, 903 of circuitry, which are shown in FIGS. 9A-9D (respectively). The LZA circuitry shown in FIGS. 9A-9D includes features of LZA unit 136 and/or LZA unit 158, in some embodiments.

The result of the main adder needs to be normalized. To speed up the normalization, the LZA is performed in parallel with the main adder. As shown in FIGS. 9A-9D, the LZA takes sum and carry from the multiply array and generates f vectors, each for a respective one of a case wherein the result is positive, or a case wherein the result is negative. One of the f vectors is then selected based on the inversion. In an embodiment, the two f vectors—f^{pos}i and f^{neg}i—are generated according to the following:

$$sum = \{ {s}_{n} , {s}_{n - 1} , … , {s}_{0} \} , carry = \{ {c}_{n} , {c}_{n - 1} , … , {c}_{0} \} \\ {g}_{i} = {s}_{i} \& {c}_{i} \\ {z}_{i} = \overline{{s}_{i} \vert {c}_{i}} \\ {f}_{i}^{pos} = ( {g}_{i} \vert {z}_{i} ) \& \overline{{z}_{i - 1}} \\ {f}_{i}^{neg} = ( {g}_{i} \vert {z}_{i} ) \& \overline{{g}_{i - 1}} \qquad ( 11 )$$

The vector f^{pos}i is for a positive result and the vector f^{neg}i is for a negative result. The f vector is selected based on the inversion, which is determined in the main adder. The inversion bit is 1 if the main adder result is negative.

In some embodiments, the LZA is configured to handle one or more underflow cases wherein the normalization shift amount is larger than the exponent. In one such embodiment, the LZA stops the normalization shift by masking one or both of the f vectors if the exponent would become less than zero after the normalization. The mask vector is generated, for example, in four levels based on the exponent-1^{st} level [0, 64, or 128], 2^{nd} level [0, 16, 32, or 48], 3^{rd} level [0, 4, 8, or 12], and 4^{th} level [0, 1, 2, or 3]. More particularly, four masks are generated, in one embodiment, according to the following:

$${m}_{lvl 1} = {m}_{0}^{64} {m}_{64}^{64} {m}_{128}^{64} \\ {m}_{lvl 2} = {m}_{0}^{16} {m}_{16}^{16} {m}_{32}^{16} {m}_{48}^{16} \\ {m}_{lvl 3} = {m}_{0}^{4} {m}_{4}^{4} {m}_{8}^{4} {m}_{12}^{4} {m}_{0}^{4} {m}_{4}^{4} … {m}_{8}^{4} {m}_{12}^{4} \\ {m}_{lvl 4} = {m}_{0} {m}_{1} {m}_{2} {m}_{3} {m}_{0} {m}_{1} {m}_{2} {m}_{3} … {m}_{2} {m}_{3} \\ m = {m}_{lvl 1} \& {m}_{lvl 2} \& {m}_{lvl 3} \& {m}_{lvl 4} \& ( exp < 128 ) \qquad ( 12 )$$

where, in a given mask, mₖⁿ represents a sequence of n bits which are each set if the exponent in question is less than or equal to k. In this particular context, “exponent” refers to a selected exponent value (i.e., the selected one of e_{M} or e_{C}) before an adjustment of said value.

In an illustrative scenario according to one embodiment, in each level, two bits of exponent are used—e.g., 1^{st} level [7:6], 2^{nd} level [5:4], 3^{rd} level [3:2], and 4^{th} level [1:0]. If exp=0x8=b′1000, it is less than 64 and 16, mₗᵥₗ₁ and mₗᵥₗ₂ are all 0, but mₗᵥₗ₃ is “0000 0000 1111 1111 . . . ”, since m₀ and m₄ is 0 (exp is larger than 0, 4) but m₈ and m₁₂ is 1 (exp is less than or equal to 8 and 12).

In some embodiments, the selected f vector is ORed with the mask vector m of a given layer, and the result is used to facilitate a count of the leading zeros. In one such embodiment, the LZA consists of four levels, which is the same as the normalization. In each level, the LZA vector is split into multiple chunks (e.g., four chunks), and the bits in each chunk are Ored to search if there are any ones. Then, one of the three or four chunks with the first one from the MSB is selected to determine a shift amount—e.g., as shown in FIGS. 9A-9D. In some embodiments, levels of the LZA are organized from coarse to fine—e.g., wherein a 1^{st} level comprises 64 bits per chunk, a 2^{nd} level comprises 16 bits per chunk, a 3^{rd} level comprises 4 bits per chunk, and a 4^{th} level comprises 1 bit per chunk. The mask vector is generated in parallel with when a f vector being generated, selected, and then ORed, in some embodiments.

FIG. 10 shows a circuit diagram illustrating features of a circuit 1000 to generate a normalized value according to an embodiment. The circuit 1000 shown in FIG. 10 includes features of normalization logic 155, in some embodiments.

As shown in FIG. 10, the result from the main adder and incrementor is passed to the normalization logic—e.g., in the third cycle unit. The normalization logic consists of four levels of shifters as shown in FIG. 10. In each level, one of three or four shift amounts is selected based on the LZA result-1^{st} level [0, 64 or 128], 2^{nd} level [0, 16, 32 or 48], 3^{rd} level [0, 4, 8 or 12], and 4^{th} level [0, 1, 2 or 3]. Since the LZA has a 1-bit error, a 1-bit right shift is needed, which is called a post-normalization. The post-normalization is needed if the O-bit (i.e., the significant overflow bit, one bit above the J-bit) is one after the normalization.

To mitigate or avoid any additional delay, the condition to indicate whether post-normalization is needed is detected in parallel with the last level of the LZA—e.g., wherein:

$$post\_norm = \{ \begin{matrix}{norm\_sig}_{lvl 3} [ MSB ] & if {lza}_{lvl 4} [ 0 ] = 1 \\ {norm\_sig}_{lvl 3} [ MSB - 1 ] & if {lza}_{lvl 4} [ 1 ] = 1 \\ {norm\_sig}_{lvl 3} [ MSB - 2 ] & if {lza}_{lvl 4} [ 2 ] = 1 \\ {norm\_sig}_{lvl 3} [ MSB - 3 ] & if {lza}_{lvl 4} [ 3 ] = 1\end{matrix} \qquad ( 13 )$$

In one example embodiment, normalization includes or is performed in addition to adjusting an exponent by subtracting the shift amount. However, unless additional functionality is provided, such subtraction could cause an underflow condition if the exponent becomes less than zero after the adjustment. One possible approach, wherein the denormalization shifter recovers the negative exponent to zero, would require additional delay.

To avoid the extra process, some embodiments provide a LZA which is adapted to stop the normalization if the exponent is less than the shift amount (so that the denormalization is unnecessary). Furthermore, underflow is detected if the J-bit after normalization is zero, which means a denormal significand result, and the exponent is set to zero.

In some embodiments, sticky and all-ones detection is performed in parallel with the normalization to speed up the rounding logic. The sticky bit in each level of the normalization is set by ORing the bits under the guard bit. The sticky bits from the four levels of the normalization and the sticky bit from the alignment are ORed to generate the final sticky bit. Likewise, all-ones in each level is set by ANDing all the bits under the LSB. The final all-ones is generated by ANDing the all-ones from the four levels of normalization. The sticky and all-ones are used in the rounding logic.

In one such embodiment, the normalized significand is passed to the rounding logic. The regular rounding is determined based on the rounding mode, a reference bit (corresponding to a LSB of an original value which is subsequently normalized at least partially), a guard bit, a sticky bit and a sign bit. In one example embodiment, a roundup value is generated according to the following:

$$roundup = \{ \begin{matrix}G \& ( L \vert S ) & if round to nearest \\ G \vert S & if round to infinity\end{matrix} \qquad ( 14 )$$

where L is the reference bit, G is a guard bit, and S is a sticky bit. In some embodiments, relatively fewer possible rounding modes (e.g., fewer than those of the IEEE-754 Standard) are provided by merging a round to +infinity mode and a round to −infinity mode. For example, in this particular instance, “round to infinity”=(!sign & round to −infinity) or (sign & round to +infinity).

Additionally or alternatively, a round to zero mode can be omitted by using an AND-OR-Invert multiplexer. By way of illustration and not limitation, round to zero corresponds to a “do not round up” mode. So, the roundup becomes 0 if nothing is selected—e.g., roundup=(RNE & G & (R|S)) or (RINF & (G|S)), wherein if both RNE and RINF are 0, roundup becomes 0, and it means round to zero.

In some embodiment, logic to provide two's complement functionality is merged with the rounding logic. In one such embodiment, the two's complement is propagated only if all the bits under the reference bit are ones, which (for example) is detected in parallel with the normalization. In certain cases, the propagated two's complement results in a forced roundup. Accordingly, the normalized significand is subject to being rounded by either a regular roundup (that is, according to the rounding mode) or a +1 roundup which is forced by virtue of the two's complement.

In an embodiment, the rounded significand needs to be shifted right by one bit if the significand overflow occurs after the rounding. Such a case occurs only if the significand bits are all ones and it is rounded up, which is detected in parallel with the normalization.

$$ov\_rndup = allones \& round\_up \qquad ( 15 )$$

If ov_rndup is detected, the significand becomes zero and the exponent is adjusted accordingly, which eliminates the re-normalization after the rounding. The rounded significand is passed to the last MUX in the fourth cycle unit to determine precision and special cases, then passed to the bypass and writeback. Significand overflow happens when the bit above the J-bit is set—e.g., where 1001+1010=10011. Such a roundup may happen after the round up only if the significand is all ones—e.g., where 1111+1=10000.

FIG. 11 shows a circuit diagram illustrating features of a circuit 1100 to support both a FMA calculation and a FMUL calculation according to an embodiment. The circuit 1100 shown in FIG. 11 includes features of round logic 131, adder 135, LZA unit 136, and/or MUX 140, in some embodiments.

As shown in FIG. 11, some embodiments also execute FMUL in 3 cycles. In one embodiment, the FMUL logic operates with at least some components—e.g., including the main adder and the LZA—of circuitry 100, which facilitates execution of an FMA instruction. FIG. 11 shows the FMUL adders and rounding logic. The result of the adder is selectively rounded and post-normalized. To speed up the rounding logic, some embodiments provide FMUL logic which performs another adder in parallel to compute the result z+2, then the result z+1 is determined based on the LSB of the result z—e.g., according to the following:

$${z}_{+ 1} [ MSB : 1 ] = \{ \begin{matrix}z [ MSB : 1 ] & if z [ 0 ] = 0 \\ {z}_{+ 2} [ MSB : 1 ] & otherwise\end{matrix} \\ {z}_{+ 1} [ 0 ] = \overline{z [ 0 ]} \qquad ( 16 )$$

In an embodiment, the FMUL rounding logic is similar to that for FMA calculation, except that is uses two cases of LSB, guard and sticky bits. The f vector from the LZA is used to generate the LSB, guard and sticky bits—e.g., according to the following:

$$LSB , guard = \{ \begin{matrix}z [ 0 : - 1 ] & if no shift \\ z [ 1 : 0 ] & if shifted\end{matrix} \\ sticky = \{ \begin{matrix}or ( f [ - 2 : {L}_{f} ] ) & if no shift \\ or ( f [ - 1 : {L}_{f} ] ) & if shifted\end{matrix} \qquad ( 17 )$$

where Lf is the LSB of the f vector. Also, the result is 1-bit right shifted for the post-normalization, which is determined by checking the O-bit of the result. The case of the significand overflow after the roundup is detected if the O-bit of the result z+1 is one and it is rounded up.

$$post\_norm = z [ MSB ] \vert ( {z}_{+ 1} [ MSB ] \& round\_up ) \qquad ( 18 )$$

One of the following four cases is selected based on the roundup and post-normalization:

| | |
|---|---|
| z, nshft | Unrounded z and no shift |
| z, shr1 | Unrounded z and 1-bit right shifted |
| z₊₁, nsft | Rounded z₊₁ and no shift |
| z₊₂, shr1 | Rounded z₊₂ and 1-bit right shifted |

In an embodiment, the FMUL is executed in 3 cycles with normal numbers, but does not support denormal numbers, since FMUL doesn't have normalization logic. Instead, FMUL uses a 4-cycle FMA execution path to support denormal numbers, if it has the denormal input or underflow output. For example, input denormal can be detected by checking if exp is equal to 0. Output underflow is detected in the exponent logic if e_{A}+e_{B}−bias≤0.

If the FMUL logic flags a denormal condition or an underflow condition, the 3-cycle FMUL result is discarded and the 4-cycle FMA result is passed to the bypass and writeback. Then, one or more younger operations are terminated, suspended or otherwise prevented—e.g., only if the one or more younger operations are dependent on the FMUL result, (which is referred to herein as a “virtual fault”). Accordingly, some embodiments execute FMUL in either 3 cycles with normal numbers, or in 4 cycles with denormal numbers (e.g., so that microcode assistance is unnecessary).

In an embodiment, exponent logic (e.g., shown in FIG. 3) computes exponent information for either of a FMA calculation or a FMUL calculation. The FMUL exponent is computed by adding e_{A} and e_{B}, and subtracted by the bias, which is 0x3ff for double and 0x7f for single precision, respectively. Then, it is adjusted by adding one if it is post-normalized, which is described in the FMUL section.

$$mul\_exp = {e}_{A} + {e}_{B} - bias + post\_norm \qquad ( 19 )$$

The FMA exponent logic computes e_{M} and e_{C}, as described herein, and selects one of them based on exp_comp. The selected exponent is adjusted by subtracting the normalization shift amount from LZA. Then, it is adjusted again by adding one or two based on the post_norm and ov_rndup, (as described herein)—e.g., according to the following:

$$fma\_exp = \{ \begin{matrix}adj\_exp + 2 & if post\_norm \& ov\_rndup \\ adj\_exp + 1 & if post\_norm ⊕ ov\_rndup \\ adj\_exp & otherwise \end{matrix} \qquad ( 20 )$$

In an illustrative scenario according to one embodiment, an FMA unit generates the virtual fault signal if FMUL flags denormal or underflow. In such a case, the flag is sent to a micro-operation scheduler (or a “reservation station”), which is responsible or scheduling whether and how operations are to be executed in a particular order.

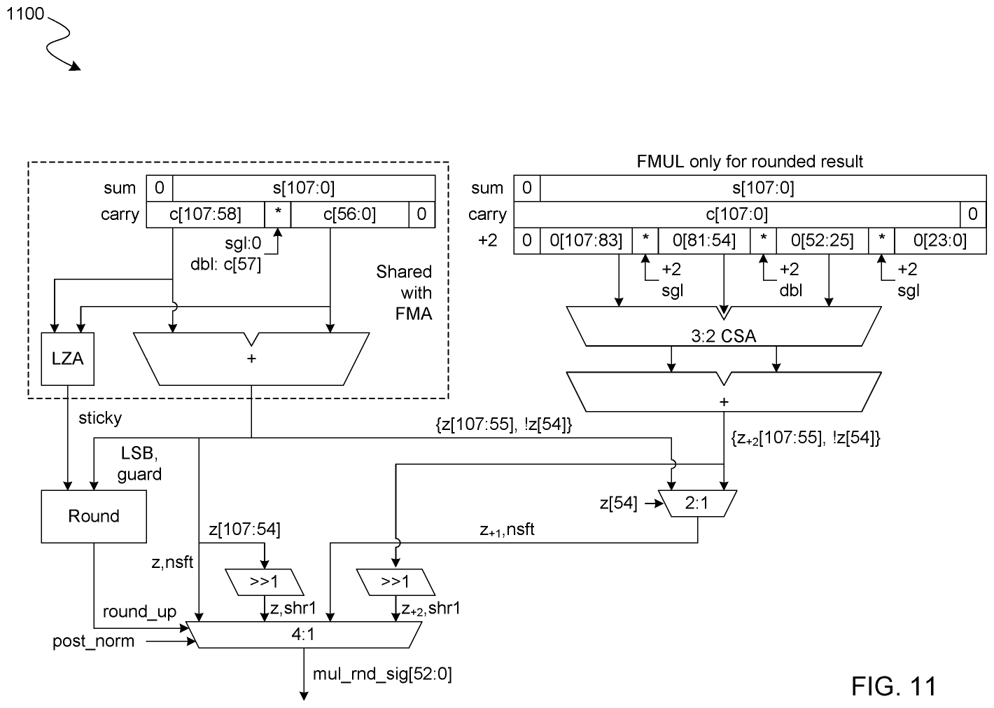

FIG. 12 illustrates examples of hardware to process an instruction. The instruction may be a multiplication instruction, such as a fused multiply-add (FMA) instruction. As illustrated, storage 1203 stores a FMA instruction 1201 to be executed. The instruction 1201 is received by decoder circuitry 1205. For example, the decoder circuitry 1205 receives this instruction from fetch circuitry (not shown). The instruction may be in any suitable format. In an example, the instruction includes fields for an opcode, two multiplicand source identifiers, and an addend source identifier (as well as for a destination identifier, in some embodiments). In an embodiment, the fields are to provide a first representation of a first multiplicand, a second representation of a second multiplicand, and a third representation of an addend—e.g., wherein each such representation is either a respective number (either a normal number or a denormal number, for example) or a respective identifier of a location of such a number. For example, the first representation, the second representation, and the third representation variously specify or otherwise indicate the operand A, the operand B, and the operand C (respectively) which are processed by circuitry 100.

In some examples, the sources (and a destination, in various embodiments) are registers, and in other examples one or more are memory locations. In some examples, one or more of the sources may be an immediate operand. In some examples, the opcode details a fused multiply-add to be performed.

More detailed examples of at least one instruction format for the instruction will be detailed later. The decoder circuitry 1205 decodes the instruction into one or more operations. In some examples, this decoding includes generating a plurality of micro-operations to be performed by execution circuitry (such as execution circuitry 1209). The decoder circuitry 1205 also decodes instruction prefixes.

In some examples, register renaming, register allocation, and/or scheduling circuitry 1207 provides functionality for one or more of: 1) renaming logical operand values to physical operand values (e.g., a register alias table in some examples), 2) allocating status bits and flags to the decoded instruction, and 3) scheduling the decoded instruction for execution by execution circuitry out of an instruction pool (e.g., using a reservation station in some examples).

Registers (register file) and/or memory 1208 store data as operands of the instruction to be operated on by execution circuitry 1209. Exemplary register types include packed data registers, general purpose registers (GPRs), and floating-point registers.

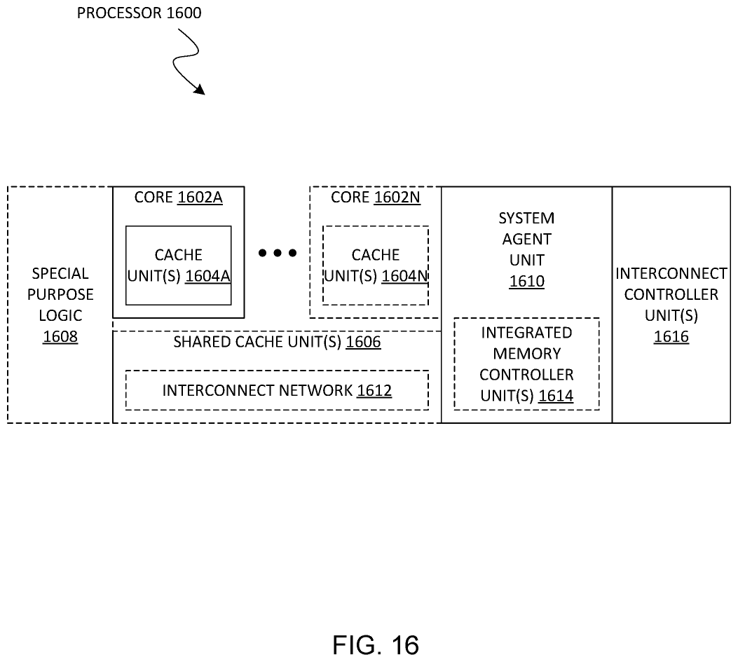

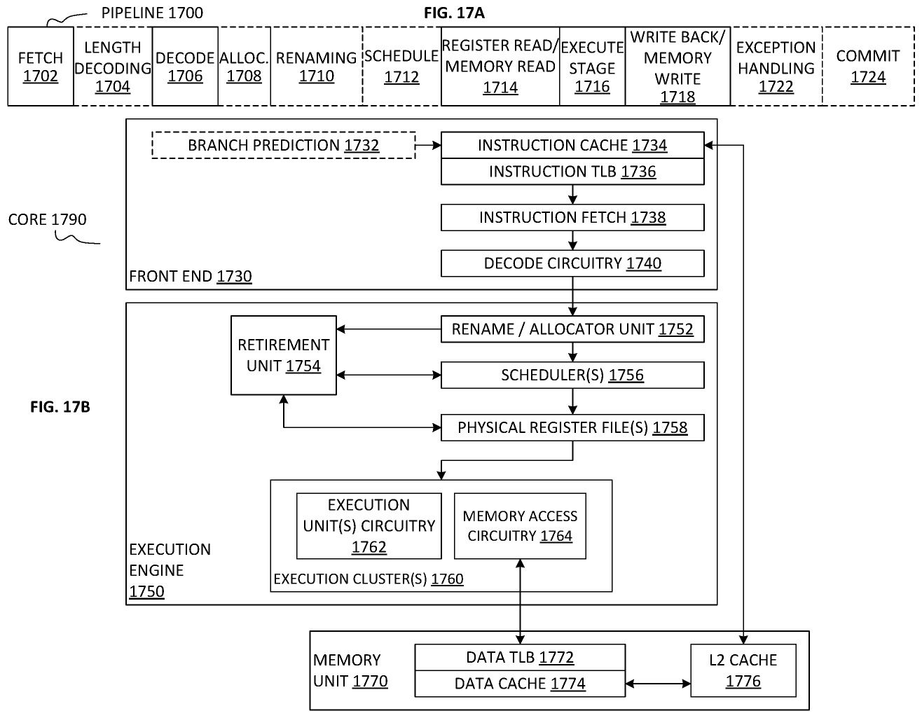

Execution circuitry 1209 executes the decoded instruction. Exemplary detailed execution circuitry includes execution cluster(s) 1760 shown in FIG. 17B, etc. The execution of the decoded instruction causes the execution circuitry to perform a FMA calculation.

In some examples, retirement/write back circuitry 1211 architecturally commits the destination register into the registers or memory 1208 and retires the instruction.

An example of a format for an FMA instruction is OPCODE DST, SRC1, SRC2, SRC3. In some examples, OPCODE is the opcode mnemonic of the instruction. DST is a field for the destination operand, such as packed data register or memory. SRC1, SRC2, SRC3 are fields for the source operands, such as packed data registers and/or memory.

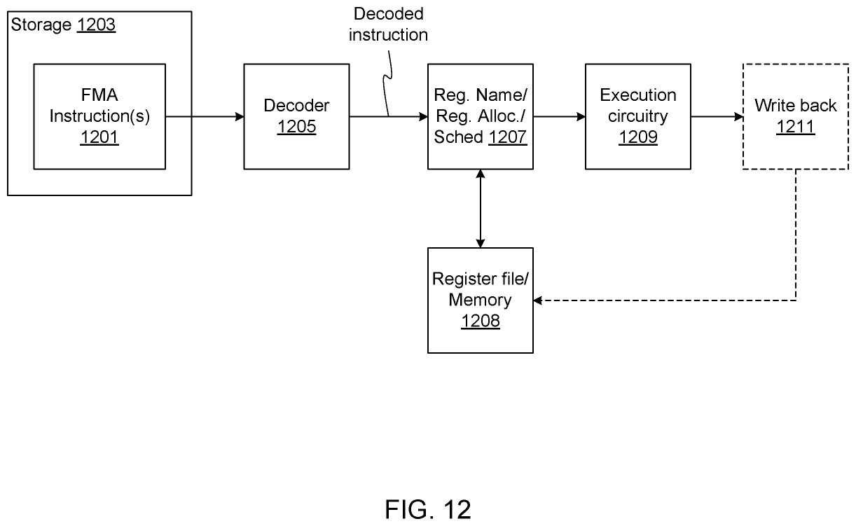

FIG. 13 illustrates an example of method performed by a processor to process a FMA instruction. For example, a processor core as shown in FIG. 17B, a pipeline as detailed below, etc., performs this method.

At 1301, an instance of single instruction is fetched. For example, an FMA instruction is fetched. The instruction includes fields for an opcode, two multiplicand source identifiers, and an addend source identifier. In some examples, the instruction further includes a field for a destination identifier, a field for a writemask, and/or the like. In some examples, the instruction is fetched from an instruction cache. The opcode indicates a FMA operation to perform.

The fetched instruction is decoded at 1303. For example, the fetched FMA instruction is decoded by decoder circuitry such as decoder circuitry 1205 or decode circuitry 1740 detailed herein.

Data values associated with the source operands of the decoded instruction are retrieved when the decoded instruction is scheduled at 1305. For example, when one or more of the source operands are memory operands, the data from the indicated memory location is retrieved.

At 1307, the decoded instruction is executed by execution circuitry (hardware) such as execution circuitry 1209 shown in FIG. 12, or execution cluster(s) 1760 shown in FIG. 17B. For the FMA instruction, the execution will cause execution circuitry to perform the operations described in connection with FIG. 12.

To illustrate certain features of various embodiments, execution of an FMA instruction by the method in FIG. 13 is described below with reference to operation of circuitry 100. However, it is to be appreciated that such description can be extended to additionally or alternatively apply to operations of any of various other suitable circuit structures.

In an embodiment, a FMA instruction comprises a first representation of a first multiplicand (e.g., the operand A), a second representation of a second multiplicand (e.g., the operand B), and a third representation of an addend (e.g., operand C). Execution of such a FMA instruction comprises generating a selection value based on a first significand value of the first representation—e.g., wherein the selection value is indicated by the “Booth select” signal 118 which encoder ENC 114 generates based on the significand value f_{A} of the operand A. In one such embodiment, the selection value is generated by a Radix-16 Booth encoding of the first significand value.

In an embodiment, executing the FMA instruction further comprises generating a plurality of values (e.g., the values 119) which each correspond to a different respective multiple of a second significand value (e.g., the value f_{B}) of the second representation. Executing the FMA instruction further comprises detecting a condition (e.g., the detecting by J-bit correction logic JBC 113) wherein one of the first representation or the second representation is a normal representation, and wherein the other of the first representation or the second representation is a denormal representation. Based on the condition, a multiplier array circuit (e.g., comprising MUL array 122) is provided with the significand value of the one of the first representation or the second representation. The multiplier array circuit performs a selection from among the plurality of values based on the selection value, and further performs a subtraction with the significand value of the one of the first representation or the second representation. A sum value and a carry value are generated with the multiplier circuit based on the first significand value, and the second significand value, and further based on a third significand value (e.g., the value f_{C}) of the addend.

In an embodiment, executing the FMA instruction further comprises providing both the sum value and the carry value to each of an adder circuit and a leading zero anticipator (LZA) circuit—e.g., wherein the adder circuit comprises some or all of adder 125, MUX 134, adder 135, MUX 141, and MUX 142, and wherein the LZA circuit comprises LZA unit 136. The adder circuit generates a fourth significand value (e.g., comprising the bits upr_sig and the bits lwr_sig) based on each of the sum value, the carry value, and further based on an aligned version of the third significand value.

For example, executing the FMA instruction further comprises generating the aligned version of the third significand value—e.g., wherein align logic 120 (for example) performs a shift of the third significand value based on a difference between a first exponent value (e.g., the value e_{A}) of the first operand, and a second exponent value (e.g., the value e_{B}) of the second operand. Such a difference is indicated, for example, by the value exp_diff. In one such embodiment, the aligned version of the third significand value is generated in parallel with a generation of the sum value and the carry value.

In an embodiment, executing the FMA instruction further comprises generating multiple values, with the LZA circuit, based on each of the sum value and the carry value, wherein the multiple values each correspond to a different respective layer of a normalization circuit (such as normalization logic 155). In one such embodiment, the LZA circuit generates the multiple values in parallel with a generation of the fourth significand value by the adder circuit. The normalization circuit performs a normalization of the fourth significand value based on the multiple values (which, for example, are indicated with signal 159). For example, based on the multiple values, the LZA circuit signals the normalization circuit to limit the normalization of the fourth significand value (e.g., by masking an f vector if an exponent would otherwise become less than zero after the normalization).

Normalization of the fourth significand value generates a fifth significand value (which, for example, circuitry 100 communicates with the signal 157). In one such embodiment, executing the FMA instruction further comprises performing an evaluation, in parallel with the normalization, to detect a condition wherein the fifth significand value includes an indication of a two's complement representation. Based on a result of the evaluation, a value is generated (e.g., by SAOD logic 152 and/or round logic 160) to indicate whether the fifth significand value is to be rounded. Based on said value (indicated, for example, by signal 161), the fifth significand value—or a rounded version thereof—is provided as a significand portion of a FMA result. In some examples, the instruction is committed or retired at 1309.

In some embodiments, execution of a FMA instruction is performed with first circuitry of a processor, wherein the processor further comprises second circuitry with which a floating point multiplication (FMUL) instruction is also able to be executed. In one such embodiment, the method shown in FIG. 13 further comprises operations (not shown) which execute a FMUL instruction with both the second circuitry and with a shared portion of the first circuitry (which is used in the execution of a FMA instruction). Such a shared portion includes the adder circuit and the LZA circuit, in various embodiments.

By way of illustration and not limitation, the FMUL instruction comprises a third representation of a third multiplicand, and a fourth representation of a fourth multiplicand. In one such embodiment, executing the FMUL instruction comprises performing an evaluation to detect an instance of an occurrence of an underflow event, or one of the third representation or the fourth representation being a denormal representation. Based on such an evaluation, the second circuitry performs a selection of one of a first provisional result (e.g., for a normal number) which is generated with the second circuitry, or a second provisional result (e.g., for a denormal number) which is generated with the adder circuit and the LZA circuit of the first circuitry. In some embodiments, a virtual fault is conditionally triggered based on the result of the evaluation.

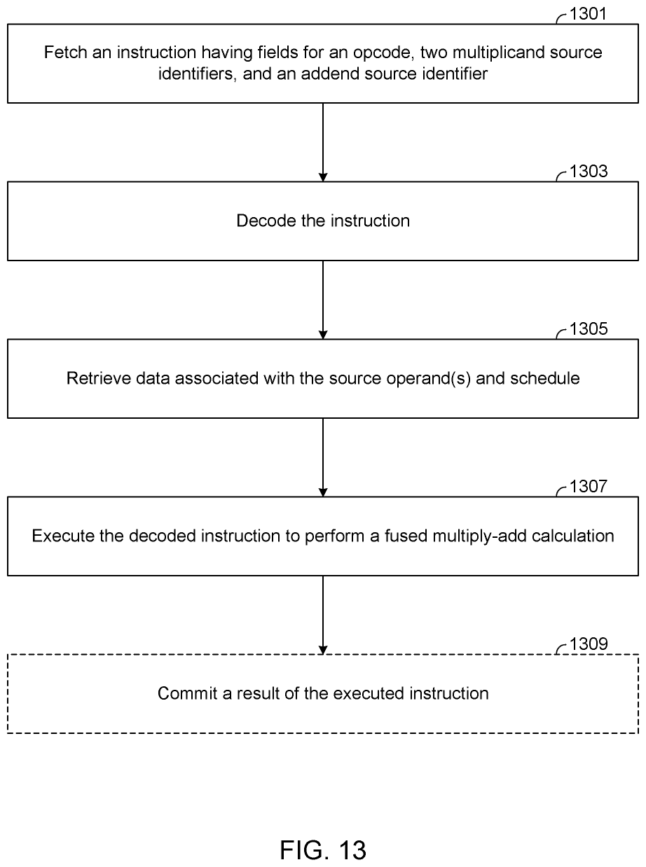

FIG. 14 illustrates an example of method to process a FMA instruction using emulation or binary translation. For example, a processor core as shown in FIG. 17B, a pipeline and/or emulation/translation layer perform aspects of this method.

An instance of a single instruction of a first instruction set architecture is fetched at 1401. The instance of the single instruction of the first instruction set architecture including fields for an opcode, two multiplicand source identifiers, and an addend source identifier (as well as for a destination identifier, in some embodiments). In some examples, the instruction further includes a field for a writemask. In some examples, the instruction is fetched from an instruction cache. The opcode indicates a FMA operation to perform.

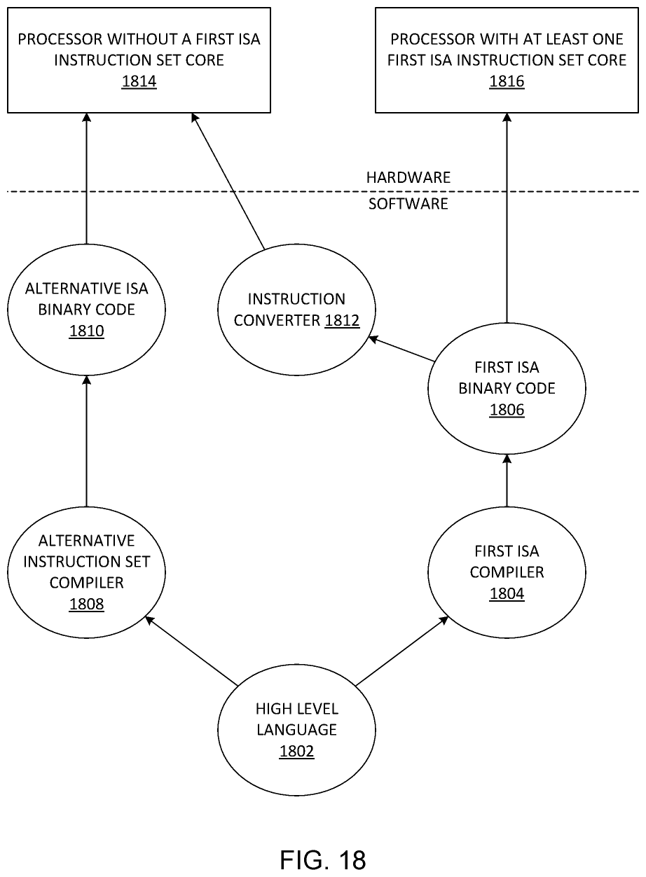

The fetched single instruction of the first instruction set architecture is translated into one or more instructions of a second instruction set architecture at 1402. This translation is performed by a translation and/or emulation layer of software in some examples. In some examples, this translation is performed by an instruction converter 1812 as shown in FIG. 18. In some examples, the translation is performed by hardware translation circuitry.

The one or more translated instructions of the second instruction set architecture are decoded at 1403. For example, the translated instructions are decoded by decoder circuitry such as decoder circuitry 1205 or decode circuitry 1740 detailed herein. In some examples, the operations of translation and decoding at 1402 and 1403 are merged.

Data values associated with the source operand(s) of the decoded one or more instructions of the second instruction set architecture are retrieved and the one or more instructions are scheduled at 1405. For example, when one or more of the source operands are memory operands, the data from the indicated memory location is retrieved.

At 1407, the decoded instruction(s) of the second instruction set architecture is/are executed by execution circuitry (hardware) such as execution circuitry 1209 shown in FIG. 12, or execution cluster(s) 1760 shown in FIG. 17B, to perform the operation(s) indicated by the opcode of the single instruction of the first instruction set architecture. For the FMA instruction, the execution will cause execution circuitry to perform the operations described in connection with FIG. 12. In various examples, execution of the decoded one or more instructions of the second instruction set comprises operations such as those described herein with respect to the method, shown in FIG. 13, for executing an FMA instruction. In some examples, the instruction is committed or retired at 1409.

### Exemplary Computer Architectures.

Detailed below are describes of exemplary computer architectures. Other system designs and configurations known in the arts for laptop, desktop, and handheld personal computers (PC)s, personal digital assistants, engineering workstations, servers, disaggregated servers, network devices, network hubs, switches, routers, embedded processors, digital signal processors (DSPs), graphics devices, video game devices, set-top boxes, micro controllers, cell phones, portable media players, hand-held devices, and various other electronic devices, are also suitable. In general, a variety of systems or electronic devices capable of incorporating a processor and/or other execution logic as disclosed herein are generally suitable.

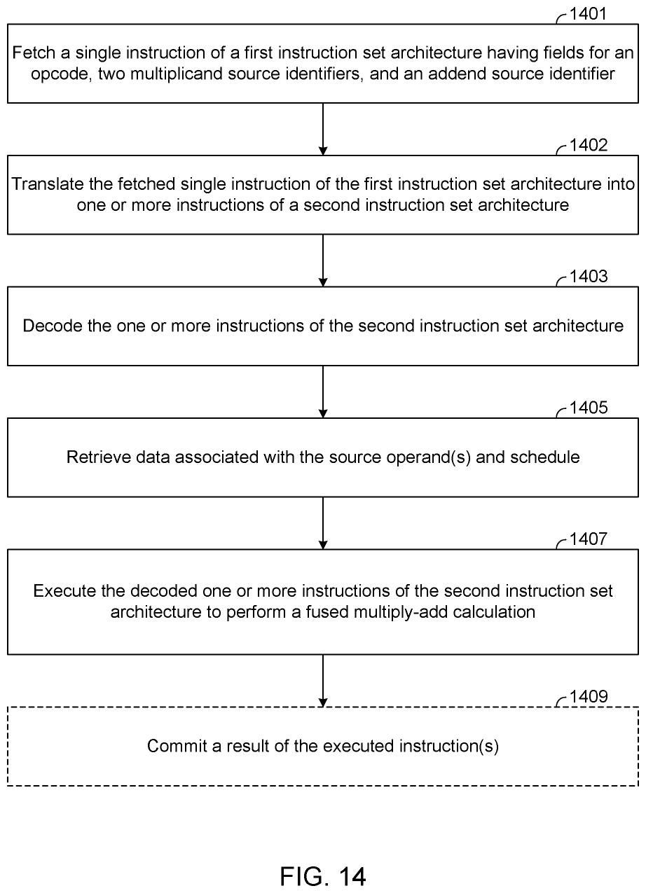

FIG. 15 illustrates an exemplary system. Multiprocessor system 1500 is a point-to-point interconnect system and includes a plurality of processors including a first processor 1570 and a second processor 1580 coupled via a point-to-point interconnect 1550. In some examples, the first processor 1570 and the second processor 1580 are homogeneous. In some examples, first processor 1570 and the second processor 1580 are heterogenous. Though the exemplary system 1500 is shown to have two processors, the system may have three or more processors, or may be a single processor system.

Processors 1570 and 1580 are shown including integrated memory controller (IMC) circuitry 1572 and 1582, respectively. Processor 1570 also includes as part of its interconnect controller point-to-point (P-P) interfaces 1576 and 1578; similarly, second processor 1580 includes P-P interfaces 1586 and 1588. Processors 1570, 1580 may exchange information via the point-to-point (P-P) interconnect 1550 using P-P interface circuits 1578, 1588. IMCs 1572 and 1582 couple the processors 1570, 1580 to respective memories, namely a memory 1532 and a memory 1534, which may be portions of main memory locally attached to the respective processors.

Processors 1570, 1580 may each exchange information with a chipset 1590 via individual P-P interconnects 1552, 1554 using point to point interface circuits 1576, 1594, 1586, 1598. Chipset 1590 may optionally exchange information with a coprocessor 1538 via an interface 1592. In some examples, the coprocessor 1538 is a special-purpose processor, such as, for example, a high-throughput processor, a network or communication processor, compression engine, graphics processor, general purpose graphics processing unit (GPGPU), neural-network processing unit (NPU), embedded processor, or the like.

A shared cache (not shown) may be included in either processor 1570, 1580 or outside of both processors, yet connected with the processors via P-P interconnect, such that either or both processors' local cache information may be stored in the shared cache if a processor is placed into a low power mode.

Chipset 1590 may be coupled to a first interconnect 1516 via an interface 1596. In some examples, first interconnect 1516 may be a Peripheral Component Interconnect (PCI) interconnect, or an interconnect such as a PCI Express interconnect or another I/O interconnect. In some examples, one of the interconnects couples to a power control unit (PCU) 1517, which may include circuitry, software, and/or firmware to perform power management operations with regard to the processors 1570, 1580 and/or co-processor 1538. PCU 1517 provides control information to a voltage regulator (not shown) to cause the voltage regulator to generate the appropriate regulated voltage. PCU 1517 also provides control information to control the operating voltage generated. In various examples, PCU 1517 may include a variety of power management logic units (circuitry) to perform hardware-based power management. Such power management may be wholly processor controlled (e.g., by various processor hardware, and which may be triggered by workload and/or power, thermal or other processor constraints) and/or the power management may be performed responsive to external sources (such as a platform or power management source or system software).

PCU 1517 is illustrated as being present as logic separate from the processor 1570 and/or processor 1580. In other cases, PCU 1517 may execute on a given one or more of cores (not shown) of processor 1570 or 1580. In some cases, PCU 1517 may be implemented as a microcontroller (dedicated or general-purpose) or other control logic configured to execute its own dedicated power management code, sometimes referred to as P-code. In yet other examples, power management operations to be performed by PCU 1517 may be implemented externally to a processor, such as by way of a separate power management integrated circuit (PMIC) or another component external to the processor. In yet other examples, power management operations to be performed by PCU 1517 may be implemented within BIOS or other system software.

Various I/O devices 1514 may be coupled to first interconnect 1516, along with a bus bridge 1518 which couples first interconnect 1516 to a second interconnect 1520. In some examples, one or more additional processor(s) 1515, such as coprocessors, high-throughput many integrated core (MIC) processors, GPGPUs, accelerators (such as graphics accelerators or digital signal processing (DSP) units), field programmable gate arrays (FPGAs), or any other processor, are coupled to first interconnect 1516. In some examples, second interconnect 1520 may be a low pin count (LPC) interconnect. Various devices may be coupled to second interconnect 1520 including, for example, a keyboard and/or mouse 1522, communication devices 1527 and a storage circuitry 1528. Storage circuitry 1528 may be one or more non-transitory machine-readable storage media as described below, such as a disk drive or other mass storage device which may include instructions/code and data 1530 and may implement the storage 1203 in some examples. Further, an audio I/O 1524 may be coupled to second interconnect 1520. Note that other architectures than the point-to-point architecture described above are possible. For example, instead of the point-to-point architecture, a system such as multiprocessor system 1500 may implement a multi-drop interconnect or other such architecture.

### Exemplary Core Architectures, Processors, and Computer Architectures.

Processor cores may be implemented in different ways, for different purposes, and in different processors. For instance, implementations of such cores may include: 1) a general purpose in-order core intended for general-purpose computing; 2) a high-performance general purpose out-of-order core intended for general-purpose computing; 3) a special purpose core intended primarily for graphics and/or scientific (throughput) computing. Implementations of different processors may include: 1) a CPU including one or more general purpose in-order cores intended for general-purpose computing and/or one or more general purpose out-of-order cores intended for general-purpose computing; and 2) a coprocessor including one or more special purpose cores intended primarily for graphics and/or scientific (throughput) computing. Such different processors lead to different computer system architectures, which may include: 1) the coprocessor on a separate chip from the CPU; 2) the coprocessor on a separate die in the same package as a CPU; 3) the coprocessor on the same die as a CPU (in which case, such a coprocessor is sometimes referred to as special purpose logic, such as integrated graphics and/or scientific (throughput) logic, or as special purpose cores); and 4) a system on a chip (SoC) that may include on the same die as the described CPU (sometimes referred to as the application core(s) or application processor(s)), the above described coprocessor, and additional functionality. Exemplary core architectures are described next, followed by descriptions of exemplary processors and computer architectures.

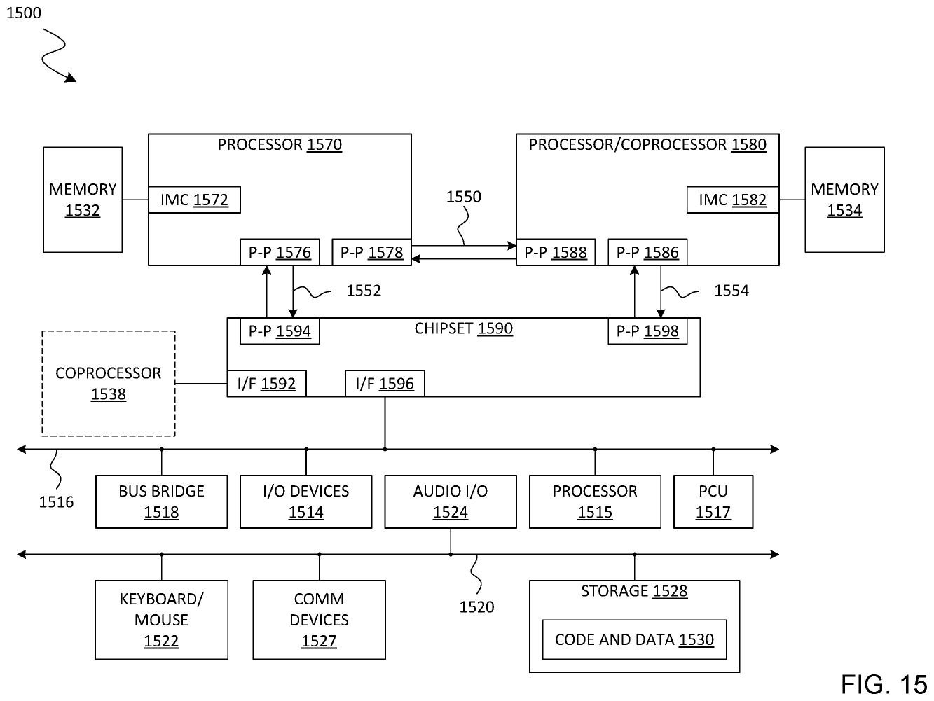

FIG. 16 illustrates a block diagram of an example processor 1600 that may have more than one core and an integrated memory controller. The solid lined boxes illustrate a processor 1600 with a single core 1602A, a system agent unit circuitry 1610, a set of one or more interconnect controller unit(s) circuitry 1616, while the optional addition of the dashed lined boxes illustrates an alternative processor 1600 with multiple cores 1602A-N, a set of one or more integrated memory controller unit(s) circuitry 1614 in the system agent unit circuitry 1610, and special purpose logic 1608, as well as a set of one or more interconnect controller units circuitry 1616. Note that the processor 1600 may be one of the processors 1570 or 1580, or co-processor 1538 or 1515 of FIG. 15.

Thus, different implementations of the processor 1600 may include: 1) a CPU with the special purpose logic 1608 being integrated graphics and/or scientific (throughput) logic (which may include one or more cores, not shown), and the cores 1602A-N being one or more general purpose cores (e.g., general purpose in-order cores, general purpose out-of-order cores, or a combination of the two); 2) a coprocessor with the cores 1602A-N being a large number of special purpose cores intended primarily for graphics and/or scientific (throughput); and 3) a coprocessor with the cores 1602A-N being a large number of general purpose in-order cores. Thus, the processor 1600 may be a general-purpose processor, coprocessor or special-purpose processor, such as, for example, a network or communication processor, compression engine, graphics processor, GPGPU (general purpose graphics processing unit circuitry), a high-throughput many integrated core (MIC) coprocessor (including 30 or more cores), embedded processor, or the like. The processor may be implemented on one or more chips. The processor 1600 may be a part of and/or may be implemented on one or more substrates using any of a number of process technologies, such as, for example, complementary metal oxide semiconductor (CMOS), bipolar CMOS (BiCMOS), P-type metal oxide semiconductor (PMOS), or N-type metal oxide semiconductor (NMOS).

A memory hierarchy includes one or more levels of cache unit(s) circuitry 1604A-N within the cores 1602A-N, a set of one or more shared cache unit(s) circuitry 1606, and external memory (not shown) coupled to the set of integrated memory controller unit(s) circuitry 1614. The set of one or more shared cache unit(s) circuitry 1606 may include one or more mid-level caches, such as level 2 (L2), level 3 (L3), level 4 (L4), or other levels of cache, such as a last level cache (LLC), and/or combinations thereof. While in some examples ring-based interconnect network circuitry 1612 interconnects the special purpose logic 1608 (e.g., integrated graphics logic), the set of shared cache unit(s) circuitry 1606, and the system agent unit circuitry 1610, alternative examples use any number of well-known techniques for interconnecting such units. In some examples, coherency is maintained between one or more of the shared cache unit(s) circuitry 1606 and cores 1602A-N.

In some examples, one or more of the cores 1602A-N are capable of multi-threading. The system agent unit circuitry 1610 includes those components coordinating and operating cores 1602A-N. The system agent unit circuitry 1610 may include, for example, power control unit (PCU) circuitry and/or display unit circuitry (not shown). The PCU may be or may include logic and components needed for regulating the power state of the cores 1602A-N and/or the special purpose logic 1608 (e.g., integrated graphics logic). The display unit circuitry is for driving one or more externally connected displays.

The cores 1602A-N may be homogenous in terms of instruction set architecture (ISA). Alternatively, the cores 1602A-N may be heterogeneous in terms of ISA; that is, a subset of the cores 1602A-N may be capable of executing an ISA, while other cores may be capable of executing only a subset of that ISA or another ISA.

### Exemplary Core Architectures-In-Order and Out-of-Order Core Block Diagram.

FIG. 17A is a block diagram illustrating both an exemplary in-order pipeline and an exemplary register renaming, out-of-order issue/execution pipeline according to examples. FIG. 17B is a block diagram illustrating both an exemplary example of an in-order architecture core and an exemplary register renaming, out-of-order issue/execution architecture core to be included in a processor according to examples. The solid lined boxes in FIGS. 17A-B illustrate the in-order pipeline and in-order core, while the optional addition of the dashed lined boxes illustrates the register renaming, out-of-order issue/execution pipeline and core. Given that the in-order aspect is a subset of the out-of-order aspect, the out-of-order aspect will be described.

In FIG. 17A, a processor pipeline 1700 includes a fetch stage 1702, an optional length decoding stage 1704, a decode stage 1706, an optional allocation (Alloc) stage 1708, an optional renaming stage 1710, a schedule (also known as a dispatch or issue) stage 1712, an optional register read/memory read stage 1714, an execute stage 1716, a write back/memory write stage 1718, an optional exception handling stage 1722, and an optional commit stage 1724. One or more operations can be performed in each of these processor pipeline stages. For example, during the fetch stage 1702, one or more instructions are fetched from instruction memory, and during the decode stage 1706, the one or more fetched instructions may be decoded, addresses (e.g., load store unit (LSU) addresses) using forwarded register ports may be generated, and branch forwarding (e.g., immediate offset or a link register (LR)) may be performed. In one example, the decode stage 1706 and the register read/memory read stage 1714 may be combined into one pipeline stage. In one example, during the execute stage 1716, the decoded instructions may be executed, LSU address/data pipelining to an Advanced Microcontroller Bus (AMB) interface may be performed, multiply and add operations may be performed, arithmetic operations with branch results may be performed, etc.

By way of example, the exemplary register renaming, out-of-order issue/execution architecture core of FIG. 17B may implement the pipeline 1700 as follows: 1) the instruction fetch circuitry 1738 performs the fetch and length decoding stages 1702 and 1704; 2) the decode circuitry 1740 performs the decode stage 1706; 3) the rename/allocator unit circuitry 1752 performs the allocation stage 1708 and renaming stage 1710; 4) the scheduler(s) circuitry 1756 performs the schedule stage 1712; 5) the physical register file(s) circuitry 1758 and the memory unit circuitry 1770 perform the register read/memory read stage 1714; the execution cluster(s) 1760 perform the execute stage 1716; 6) the memory unit circuitry 1770 and the physical register file(s) circuitry 1758 perform the write back/memory write stage 1718; 7) various circuitry may be involved in the exception handling stage 1722; and 8) the retirement unit circuitry 1754 and the physical register file(s) circuitry 1758 perform the commit stage 1724.

FIG. 17B shows a processor core 1790 including front-end unit circuitry 1730 coupled to an execution engine unit circuitry 1750, and both are coupled to a memory unit circuitry 1770. The core 1790 may be a reduced instruction set architecture computing (RISC) core, a complex instruction set architecture computing (CISC) core, a very long instruction word (VLIW) core, or a hybrid or alternative core type. As yet another option, the core 1790 may be a special-purpose core, such as, for example, a network or communication core, compression engine, coprocessor core, general purpose computing graphics processing unit (GPGPU) core, graphics core, or the like.

The front end unit circuitry 1730 may include branch prediction circuitry 1732 coupled to an instruction cache circuitry 1734, which is coupled to an instruction translation lookaside buffer (TLB) 1736, which is coupled to instruction fetch circuitry 1738, which is coupled to decode circuitry 1740. In one example, the instruction cache circuitry 1734 is included in the memory unit circuitry 1770 rather than the front-end circuitry 1730. The decode circuitry 1740 (or decoder) may decode instructions, and generate as an output one or more micro-operations, micro-code entry points, microinstructions, other instructions, or other control signals, which are decoded from, or which otherwise reflect, or are derived from, the original instructions. The decode circuitry 1740 may further include an address generation unit (AGU, not shown) circuitry. In one example, the AGU generates an LSU address using forwarded register ports, and may further perform branch forwarding (e.g., immediate offset branch forwarding, LR register branch forwarding, etc.). The decode circuitry 1740 may be implemented using various different mechanisms. Examples of suitable mechanisms include, but are not limited to, look-up tables, hardware implementations, programmable logic arrays (PLAs), microcode read only memories (ROMs), etc. In one example, the core 1790 includes a microcode ROM (not shown) or other medium that stores microcode for certain macroinstructions (e.g., in decode circuitry 1740 or otherwise within the front end circuitry 1730). In one example, the decode circuitry 1740 includes a micro-operation (micro-op) or operation cache (not shown) to hold/cache decoded operations, micro-tags, or micro-operations generated during the decode or other stages of the processor pipeline 1700. The decode circuitry 1740 may be coupled to rename/allocator unit circuitry 1752 in the execution engine circuitry 1750.

The execution engine circuitry 1750 includes the rename/allocator unit circuitry 1752 coupled to a retirement unit circuitry 1754 and a set of one or more scheduler(s) circuitry 1756. The scheduler(s) circuitry 1756 represents any number of different schedulers, including reservations stations, central instruction window, etc. In some examples, the scheduler(s) circuitry 1756 can include arithmetic logic unit (ALU) scheduler/scheduling circuitry, ALU queues, arithmetic generation unit (AGU) scheduler/scheduling circuitry, AGU queues, etc. The scheduler(s) circuitry 1756 is coupled to the physical register file(s) circuitry 1758. Each of the physical register file(s) circuitry 1758 represents one or more physical register files, different ones of which store one or more different data types, such as scalar integer, scalar floating-point, packed integer, packed floating-point, vector integer, vector floating-point, status (e.g., an instruction pointer that is the address of the next instruction to be executed), etc. In one example, the physical register file(s) circuitry 1758 includes vector registers unit circuitry, writemask registers unit circuitry, and scalar register unit circuitry. These register units may provide architectural vector registers, vector mask registers, general-purpose registers, etc. The physical register file(s) circuitry 1758 is coupled to the retirement unit circuitry 1754 (also known as a retire queue or a retirement queue) to illustrate various ways in which register renaming and out-of-order execution may be implemented (e.g., using a reorder buffer(s) (ROB(s)) and a retirement register file(s); using a future file(s), a history buffer(s), and a retirement register file(s); using a register maps and a pool of registers; etc.). The retirement unit circuitry 1754 and the physical register file(s) circuitry 1758 are coupled to the execution cluster(s) 1760. The execution cluster(s) 1760 includes a set of one or more execution unit(s) circuitry 1762 and a set of one or more memory access circuitry 1764. The execution unit(s) circuitry 1762 may perform various arithmetic, logic, floating-point or other types of operations (e.g., shifts, addition, subtraction, multiplication) and on various types of data (e.g., scalar integer, scalar floating-point, packed integer, packed floating-point, vector integer, vector floating-point). While some examples may include a number of execution units or execution unit circuitry dedicated to specific functions or sets of functions, other examples may include only one execution unit circuitry or multiple execution units/execution unit circuitry that all perform all functions. The scheduler(s) circuitry 1756, physical register file(s) circuitry 1758, and execution cluster(s) 1760 are shown as being possibly plural because certain examples create separate pipelines for certain types of data/operations (e.g., a scalar integer pipeline, a scalar floating-point/packed integer/packed floating-point/vector integer/vector floating-point pipeline, and/or a memory access pipeline that each have their own scheduler circuitry, physical register file(s) circuitry, and/or execution cluster—and in the case of a separate memory access pipeline, certain examples are implemented in which only the execution cluster of this pipeline has the memory access unit(s) circuitry 1764). It should also be understood that where separate pipelines are used, one or more of these pipelines may be out-of-order issue/execution and the rest in-order.

In some examples, the execution engine unit circuitry 1750 may perform load store unit (LSU) address/data pipelining to an Advanced Microcontroller Bus (AMB) interface (not shown), and address phase and writeback, data phase load, store, and branches.

The set of memory access circuitry 1764 is coupled to the memory unit circuitry 1770, which includes data TLB circuitry 1772 coupled to a data cache circuitry 1774 coupled to a level 2 (L2) cache circuitry 1776. In one exemplary example, the memory access circuitry 1764 may include a load unit circuitry, a store address unit circuit, and a store data unit circuitry, each of which is coupled to the data TLB circuitry 1772 in the memory unit circuitry 1770. The instruction cache circuitry 1734 is further coupled to the level 2 (L2) cache circuitry 1776 in the memory unit circuitry 1770. In one example, the instruction cache 1734 and the data cache 1774 are combined into a single instruction and data cache (not shown) in L2 cache circuitry 1776, a level 3 (L3) cache circuitry (not shown), and/or main memory. The L2 cache circuitry 1776 is coupled to one or more other levels of cache and eventually to a main memory.

The core 1790 may support one or more instructions sets (e.g., the x86 instruction set architecture (optionally with some extensions that have been added with newer versions); the MIPS instruction set architecture; the ARM instruction set architecture (optionally with optional additional extensions such as NEON)), including the instruction(s) described herein. In one example, the core 1790 includes logic to support a packed data instruction set architecture extension (e.g., AVX1, AVX2), thereby allowing the operations used by many multimedia applications to be performed using packed data.

One or more aspects of at least one example may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor.

Such machine-readable storage media may include, without limitation, non-transitory, tangible arrangements of articles manufactured or formed by a machine or device, including storage media such as hard disks, any other type of disk including floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), phase change memory (PCM), magnetic or optical cards, or any other type of media suitable for storing electronic instructions.

Accordingly, examples also include non-transitory, tangible machine-readable media containing instructions or containing design data, such as Hardware Description Language (HDL), which defines structures, circuits, apparatuses, processors and/or system features described herein. Such examples may also be referred to as program products.

### Emulation (Including Binary Translation, Code Morphing, Etc.).

In some cases, an instruction converter may be used to convert an instruction from a source instruction set architecture to a target instruction set architecture. For example, the instruction converter may translate (e.g., using static binary translation, dynamic binary translation including dynamic compilation), morph, emulate, or otherwise convert an instruction to one or more other instructions to be processed by the core. The instruction converter may be implemented in software, hardware, firmware, or a combination thereof. The instruction converter may be on processor, off processor, or part on and part off processor.

FIG. 18 illustrates a block diagram contrasting the use of a software instruction converter to convert binary instructions in a source instruction set architecture to binary instructions in a target instruction set architecture according to examples. In the illustrated example, the instruction converter is a software instruction converter, although alternatively the instruction converter may be implemented in software, firmware, hardware, or various combinations thereof. FIG. 18 shows a program in a high-level language 1802 may be compiled using a first ISA compiler 1804 to generate first ISA binary code 1806 that may be natively executed by a processor with at least one first instruction set architecture core 1816. The processor with at least one first ISA instruction set architecture core 1816 represents any processor that can perform substantially the same functions as an Intel® processor with at least one first ISA instruction set architecture core by compatibly executing or otherwise processing (1) a substantial portion of the instruction set architecture of the first ISA instruction set architecture core or (2) object code versions of applications or other software targeted to run on an Intel processor with at least one first ISA instruction set architecture core, in order to achieve substantially the same result as a processor with at least one first ISA instruction set architecture core. The first ISA compiler 1804 represents a compiler that is operable to generate first ISA binary code 1806 (e.g., object code) that can, with or without additional linkage processing, be executed on the processor with at least one first ISA instruction set architecture core 1816. Similarly, FIG. 18 shows the program in the high-level language 1802 may be compiled using an alternative instruction set architecture compiler 1808 to generate alternative instruction set architecture binary code 1810 that may be natively executed by a processor without a first ISA instruction set architecture core 1814. The instruction converter 1812 is used to convert the first ISA binary code 1806 into code that may be natively executed by the processor without a first ISA instruction set architecture core 1814. This converted code is not necessarily to be the same as the alternative instruction set architecture binary code 1810; however, the converted code will accomplish the general operation and be made up of instructions from the alternative instruction set architecture. Thus, the instruction converter 1812 represents software, firmware, hardware, or a combination thereof that, through emulation, simulation or any other process, allows a processor or other electronic device that does not have a first ISA instruction set architecture processor or core to execute the first ISA binary code 1806.

References to “one example,” “an example,” etc., indicate that the example described may include a particular feature, structure, or characteristic, but every example may not necessarily include the particular feature, structure, or characteristic. Moreover, such phrases are not necessarily referring to the same example. Further, when a particular feature, structure, or characteristic is described in connection with an example, it is submitted that it is within the knowledge of one skilled in the art to affect such feature, structure, or characteristic in connection with other examples whether or not explicitly described.

Moreover, in the various examples described above, unless specifically noted otherwise, disjunctive language such as the phrase “at least one of A, B, or C” or “A, B, and/or C” is intended to be understood to mean either A, B, or C, or any combination thereof (i.e. A and B, A and C, B and C, and A, B and C).

The specification and drawings are, accordingly, to be regarded in an illustrative rather than a restrictive sense. It will, however, be evident that various modifications and changes may be made thereunto without departing from the broader spirit and scope of the disclosure as set forth in the claims.

In the following description, numerous details are discussed to provide a more thorough explanation of the embodiments of the present disclosure. It will be apparent to one skilled in the art, however, that embodiments of the present disclosure may be practiced without these specific details. In other instances, well-known structures and devices are shown in block diagram form, rather than in detail, in order to avoid obscuring embodiments of the present disclosure.

Note that in the corresponding drawings of the embodiments, signals are represented with lines. Some lines may be thicker, to indicate a greater number of constituent signal paths, and/or have arrows at one or more ends, to indicate a direction of information flow. Such indications are not intended to be limiting. Rather, the lines are used in connection with one or more exemplary embodiments to facilitate easier understanding of a circuit or a logical unit. Any represented signal, as dictated by design needs or preferences, may actually comprise one or more signals that may travel in either direction and may be implemented with any suitable type of signal scheme.

Throughout the specification, and in the claims, the term “connected” means a direct connection, such as electrical, mechanical, or magnetic connection between the things that are connected, without any intermediary devices. The term “coupled” means a direct or indirect connection, such as a direct electrical, mechanical, or magnetic connection between the things that are connected or an indirect connection, through one or more passive or active intermediary devices. The term “circuit” or “module” may refer to one or more passive and/or active components that are arranged to cooperate with one another to provide a desired function. The term “signal” may refer to at least one current signal, voltage signal, magnetic signal, or data/clock signal. The meaning of “a,” “an,” and “the” include plural references. The meaning of “in” includes “in” and “on.”

The term “device” may generally refer to an apparatus according to the context of the usage of that term. For example, a device may refer to a stack of layers or structures, a single structure or layer, a connection of various structures having active and/or passive elements, etc. Generally, a device is a three-dimensional structure with a plane along the x-y direction and a height along the z direction of an x-y-z Cartesian coordinate system. The plane of the device may also be the plane of an apparatus which comprises the device.

The term “scaling” generally refers to converting a design (schematic and layout) from one process technology to another process technology and subsequently being reduced in layout area. The term “scaling” generally also refers to downsizing layout and devices within the same technology node. The term “scaling” may also refer to adjusting (e.g., slowing down or speeding up—i.e. scaling down, or scaling up respectively) of a signal frequency relative to another parameter, for example, power supply level.

The terms “substantially,” “close,” “approximately,” “near,” and “about,” generally refer to being within +/−10% of a target value. For example, unless otherwise specified in the explicit context of their use, the terms “substantially equal,” “about equal” and “approximately equal” mean that there is no more than incidental variation between among things so described. In the art, such variation is typically no more than +/−10% of a predetermined target value.

It is to be understood that the terms so used are interchangeable under appropriate circumstances such that the embodiments of the invention described herein are, for example, capable of operation in other orientations than those illustrated or otherwise described herein.

Unless otherwise specified the use of the ordinal adjectives “first,” “second,” and “third,” etc., to describe a common object, merely indicate that different instances of like objects are being referred to and are not intended to imply that the objects so described must be in a given sequence, either temporally, spatially, in ranking or in any other manner.

The terms “left,” “right,” “front,” “back,” “top,” “bottom,” “over,” “under,” and the like in the description and in the claims, if any, are used for descriptive purposes and not necessarily for describing permanent relative positions. For example, the terms “over,” “under,” “front side,” “back side,” “top,” “bottom,” “over,” “under,” and “on” as used herein refer to a relative position of one component, structure, or material with respect to other referenced components, structures or materials within a device, where such physical relationships are noteworthy. These terms are employed herein for descriptive purposes only and predominantly within the context of a device z-axis and therefore may be relative to an orientation of a device. Hence, a first material “over” a second material in the context of a figure provided herein may also be “under” the second material if the device is oriented upside-down relative to the context of the figure provided. In the context of materials, one material disposed over or under another may be directly in contact or may have one or more intervening materials. Moreover, one material disposed between two materials may be directly in contact with the two layers or may have one or more intervening layers. In contrast, a first material “on” a second material is in direct contact with that second material. Similar distinctions are to be made in the context of component assemblies.

The term “between” may be employed in the context of the z-axis, x-axis or y-axis of a device. A material that is between two other materials may be in contact with one or both of those materials, or it may be separated from both of the other two materials by one or more intervening materials. A material “between” two other materials may therefore be in contact with either of the other two materials, or it may be coupled to the other two materials through an intervening material. A device that is between two other devices may be directly connected to one or both of those devices, or it may be separated from both of the other two devices by one or more intervening devices.

As used throughout this description, and in the claims, a list of items joined by the term “at least one of” or “one or more of” can mean any combination of the listed terms. For example, the phrase “at least one of A, B or C” can mean A; B; C; A and B; A and C; B and C; or A, B and C. It is pointed out that those elements of a figure having the same reference numbers (or names) as the elements of any other figure can operate or function in any manner similar to that described, but are not limited to such.

In addition, the various elements of combinatorial logic and sequential logic discussed in the present disclosure may pertain both to physical structures (such as AND gates, OR gates, or XOR gates), or to synthesized or otherwise optimized collections of devices implementing the logical structures that are Boolean equivalents of the logic under discussion.

Techniques and architectures for a processor to execute an instruction are described herein. In the above description, for purposes of explanation, numerous specific details are set forth in order to provide a thorough understanding of certain embodiments. It will be apparent, however, to one skilled in the art that certain embodiments can be practiced without these specific details. In other instances, structures and devices are shown in block diagram form in order to avoid obscuring the description.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

Some portions of the detailed description herein are presented in terms of algorithms and symbolic representations of operations on data bits within a computer memory. These algorithmic descriptions and representations are the means used by those skilled in the computing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the discussion herein, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Certain embodiments also relate to apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs) such as dynamic RAM (DRAM), EPROMS, EEPROMs, magnetic or optical cards, or any type of media suitable for storing electronic instructions, and coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear from the description herein. In addition, certain embodiments are not described with reference to any particular programming language. It will be appreciated that a variety of programming languages may be used to implement the teachings of such embodiments as described herein.

In one or more first embodiments, a processor comprises decoder circuitry to decode a fused multiply-add (FMA) instruction to generate a decoded FMA instruction which comprises a first representation of a first multiplicand, and a second representation of a second multiplicand, and first circuitry coupled to the decoder circuitry, the first circuitry to execute the decoded FMA instruction, comprising the first circuitry to generate a selection value based on a first significand value of the first representation, and generate a plurality of values which each correspond to a different respective multiple of a second significand value of the second representation, detect a condition wherein one of the first representation or the second representation is a normal representation, and wherein the other of the first representation or the second representation is a denormal representation, based on the condition, provide to a multiplier array circuit one of the first significand value or the second significand value, and with the multiplier array circuit, perform a selection from among the plurality of values based on the selection value, and further perform a subtraction with the one of the first significand value or the second significand value.

In one or more second embodiments, further to the first embodiment, the first circuitry to generate the selection value comprises the first circuitry to perform a Radix-16 Booth encode operation based on the first significand value.

In one or more third embodiments, further to the first embodiment or the second embodiment, the decoded FMA instruction further comprises a third representation of an addend, a sum value and a carry value is to be generated with the multiplier array circuit based on the first significand value, the second significand value, and a third significand value of the addend, the first circuitry to execute the decoded FMA instruction comprises the first circuitry further to provide both the sum value and the carry value to each of an adder circuit and a leading zero anticipator (LZA) circuit, with the adder circuit, generate a fourth significand value based on each of the sum value, the carry value, and further based on an aligned version of the third significand value, with the LZA circuit, generate multiple values based on each of the sum value and the carry value, wherein the multiple values each correspond to a different respective layer of a normalization circuit, and wherein the LZA circuit generates the multiple values in parallel with a generation of the fourth significand value by the adder circuit, and with the normalization circuit, perform a normalization of the fourth significand value based on the multiple values.

In one or more fourth embodiments, further to the third embodiment, the first circuitry to execute the decoded FMA instruction comprises the first circuitry further to generate the aligned version of the third significand value, comprising the first circuitry perform a shift of the third significand value based on a difference between a first exponent value of the first operand, and a second exponent value of the second operand.

In one or more fifth embodiments, further to the fourth embodiment, the first circuitry is to generate the aligned version of the third significand value in parallel with a generation of the sum value and the carry value.

In one or more sixth embodiments, further to the third embodiment, the LZA circuit is to signal the normalization circuit, based on the multiple values, to limit the normalization of the fourth significand value.

In one or more seventh embodiments, further to the third embodiment, the normalization of the fourth significand value is to generate a fifth significand value, and the first circuitry to execute the decoded FMA instruction comprises the first circuitry further to perform an evaluation, in parallel with the normalization, to detect a condition wherein the fifth significand value includes an indication of a two's complement representation, provide a first value comprising a result of the evaluation, generate a second value, based on the first value, which indicates whether the fifth significand value is to be rounded, and round the fifth significand value with the second value to generate a sixth significand value.

In one or more eighth embodiments, further to any of the first through third embodiments, the processor further comprises second circuitry to execute a floating point multiplication (FMUL) instruction with an adder circuit and a leading zero anticipator (LZA) circuit of the first circuitry.

In one or more ninth embodiments, further to the eighth embodiment, the FMUL instruction comprises a third representation of a third multiplicand, and a fourth representation of a fourth multiplicand, and the second circuitry to execute the FMUL instruction comprises the second circuitry to perform an evaluation to detect an instance of an occurrence of an underflow event, or one of the third representation or the fourth representation being a denormal representation, and perform, based on the evaluation, a selection of one of a first provisional result which is generated with the second circuitry, or a second provisional result which is generated with the adder circuit and the LZA circuit of the first circuitry.

In one or more tenth embodiments, a method at a processor comprises executing a fused multiply-add (FMA) instruction which comprises a first representation of a first multiplicand, and a second representation of a second multiplicand, wherein executing the FMA instruction comprises generating a selection value based on a first significand value of the first representation, and generating a plurality of values which each correspond to a different respective multiple of a second significand value of the second representation, detecting a condition wherein one of the first representation or the second representation is a normal representation, and wherein the other of the first representation or the second representation is a denormal representation, based on the condition, providing to a multiplier array circuit one of the first significand value or the second significand value, and with the multiplier array circuit, performing a selection from among the plurality of values based on the selection value, and further perform a subtraction with the one of the first significand value or the second significand value.

In one or more eleventh embodiments, further to the tenth embodiment, generating the selection value comprises performing a Radix-16 Booth encode operation based on the first significand value.

In one or more twelfth embodiments, further to the tenth embodiment or the eleventh embodiment, the FMA instruction further comprises a third representation of an addend, a sum value and a carry value is generated with the multiplier array circuit based on the first significand value, the second significand value, and a third significand value of the addend, executing the FMA instruction further comprises providing both the sum value and the carry value to each of an adder circuit and a leading zero anticipator (LZA) circuit, with the adder circuit, generating a fourth significand value based on each of the sum value, the carry value, and further based on an aligned version of the third significand value, with the LZA circuit, generating multiple values based on each of the sum value and the carry value, wherein the multiple values each correspond to a different respective layer of a normalization circuit, and wherein the LZA circuit generates the multiple values in parallel with a generation of the fourth significand value by the adder circuit, and with the normalization circuit, performing a normalization of the fourth significand value based on the multiple values.

In one or more thirteenth embodiments, further to the twelfth embodiment, executing the FMA instruction further comprises generating the aligned version of the third significand value, comprising the first circuitry perform a shift of the third significand value based on a difference between a first exponent value of the first operand, and a second exponent value of the second operand.

In one or more fourteenth embodiments, further to the thirteenth embodiment, the aligned version of the third significand value is generated in parallel with a generation of the sum value and the carry value.

In one or more fifteenth embodiments, further to the twelfth embodiment, the LZA circuit signals the normalization circuit, based on the multiple values, to limit the normalization of the fourth significand value.

In one or more sixteenth embodiments, further to the twelfth embodiment, the normalization of the fourth significand value generates a fifth significand value, and executing the FMA instruction further comprises performing an evaluation, in parallel with the normalization, to detect a condition wherein the fifth significand value includes an indication of a two's complement representation, providing a first value comprising a result of the evaluation, generating a second value, based on the first value, which indicates whether the fifth significand value is to be rounded, and rounding the fifth significand value with the second value to generate a sixth significand value.

In one or more seventeenth embodiments, further to any of the tenth through twelfth embodiments, the method further comprises executing a floating point multiplication (FMUL) instruction with an adder circuit and a leading zero anticipator (LZA) circuit.

In one or more eighteenth embodiments, further to the seventeenth embodiment, the FMUL instruction comprises a third representation of a third multiplicand, and a fourth representation of a fourth multiplicand, and executing the FMUL instruction comprises performing an evaluation to detect an instance of an occurrence of an underflow event, or one of the third representation or the fourth representation being a denormal representation, and performing, based on the evaluation, a selection of one of a first provisional result which is generated with the second circuitry, or a second provisional result which is generated with the adder circuit and the LZA circuit of the first circuitry.

In one or more nineteenth embodiments, a system comprises a memory to store a fused multiply-add (FMA) instruction which comprises a first representation of a first multiplicand, and a second representation of a second multiplicand, a processor coupled to the memory, the processor comprising decoder circuitry to decode a fused multiply-add (FMA) instruction to generate a decoded FMA instruction which comprises a first representation of a first multiplicand, and a second representation of a second multiplicand, and first circuitry coupled to the decoder circuitry, the first circuitry to execute the decoded FMA instruction, comprising the first circuitry to generate a selection value based on a first significand value of the first representation, and generate a plurality of values which each correspond to a different respective multiple of a second significand value of the second representation, detect a condition wherein one of the first representation or the second representation is a normal representation, and wherein the other of the first representation or the second representation is a denormal representation, based on the condition, provide to a multiplier array circuit one of the first significand value or the second significand value, and with the multiplier array circuit, perform a selection from among the plurality of values based on the selection value, and further perform a subtraction with the one of the first significand value or the second significand value.

In one or more twentieth embodiments, further to the nineteenth embodiment, the first circuitry to generate the selection value comprises the first circuitry to perform a Radix-16 Booth encode operation based on the first significand value.

In one or more twenty-first embodiments, further to the nineteenth embodiment or the twentieth embodiment, the decoded FMA instruction further comprises a third representation of an addend, a sum value and a carry value is to be generated with the multiplier array circuit based on the first significand value, the second significand value, and a third significand value of the addend, the first circuitry to execute the decoded FMA instruction comprises the first circuitry further to provide both the sum value and the carry value to each of an adder circuit and a leading zero anticipator (LZA) circuit, with the adder circuit, generate a fourth significand value based on each of the sum value, the carry value, and further based on an aligned version of the third significand value, with the LZA circuit, generate multiple values based on each of the sum value and the carry value, wherein the multiple values each correspond to a different respective layer of a normalization circuit, and wherein the LZA circuit generates the multiple values in parallel with a generation of the fourth significand value by the adder circuit, and with the normalization circuit, perform a normalization of the fourth significand value based on the multiple values.

In one or more twenty-second embodiments, further to the twenty-first embodiment, the first circuitry to execute the decoded FMA instruction comprises the first circuitry further to generate the aligned version of the third significand value, comprising the first circuitry perform a shift of the third significand value based on a difference between a first exponent value of the first operand, and a second exponent value of the second operand.

In one or more twenty-third embodiments, further to the twenty-second embodiment, the first circuitry is to generate the aligned version of the third significand value in parallel with a generation of the sum value and the carry value.

In one or more twenty-fourth embodiments, further to the twenty-first embodiment, the LZA circuit is to signal the normalization circuit, based on the multiple values, to limit the normalization of the fourth significand value.

In one or more twenty-fifth embodiments, further to the twenty-first embodiment, the normalization of the fourth significand value is to generate a fifth significand value, and the first circuitry to execute the decoded FMA instruction comprises the first circuitry further to perform an evaluation, in parallel with the normalization, to detect a condition wherein the fifth significand value includes an indication of a two's complement representation, provide a first value comprising a result of the evaluation, generate a second value, based on the first value, which indicates whether the fifth significand value is to be rounded, and round the fifth significand value with the second value to generate a sixth significand value.

In one or more twenty-sixth embodiments, further to any of the nineteenth through twenty-first embodiments, the processor further comprises second circuitry to execute a floating point multiplication (FMUL) instruction with an adder circuit and a leading zero anticipator (LZA) circuit of the first circuitry.

In one or more twenty-seventh embodiments, further to the twenty-sixth embodiment, the FMUL instruction comprises a third representation of a third multiplicand, and a fourth representation of a fourth multiplicand, and the second circuitry to execute the FMUL instruction comprises the second circuitry to perform an evaluation to detect an instance of an occurrence of an underflow event, or one of the third representation or the fourth representation being a denormal representation, and perform, based on the evaluation, a selection of one of a first provisional result which is generated with the second circuitry, or a second provisional result which is generated with the adder circuit and the LZA circuit of the first circuitry.

Besides what is described herein, various modifications may be made to the disclosed embodiments and implementations thereof without departing from their scope. Therefore, the illustrations and examples herein should be construed in an illustrative, and not a restrictive sense. The scope of the invention should be measured solely by reference to the claims that follow.

What is claimed is:

1. A processor comprising:
decoder circuitry to decode a fused multiply-add (FMA) instruction to generate a decoded FMA instruction which comprises a first representation of a first multiplicand, and a second representation of a second multiplicand; and
first circuitry coupled to the decoder circuitry, the first circuitry to execute the decoded FMA instruction, comprising the first circuitry to:
generate a selection value based on a first significand value of the first representation; and
generate a plurality of values which each correspond to a different respective multiple of a second significand value of the second representation;
detect a condition wherein one of the first representation or the second representation is a normal representation, and wherein the other of the first representation or the second representation is a denormal representation;
based on the condition, provide to a multiplier array circuit one of the first significand value or the second significand value; and
with the multiplier array circuit, perform a selection from among the plurality of values based on the selection value, and further perform a subtraction with the one of the first significand value or the second significand value.

2. The processor of claim 1, wherein the first circuitry to generate the selection value comprises the first circuitry to perform a Radix-16 Booth encode operation based on the first significand value.

3. The processor of claim 1, wherein:
the decoded FMA instruction further comprises a third representation of an addend;
a sum value and a carry value is to be generated with the multiplier array circuit based on the first significand value, the second significand value, and a third significand value of the addend;
the first circuitry to execute the decoded FMA instruction comprises the first circuitry further to:
provide both the sum value and the carry value to each of an adder circuit and a leading zero anticipator (LZA) circuit;
with the adder circuit, generate a fourth significand value based on each of the sum value, the carry value, and further based on an aligned version of the third significand value;
with the LZA circuit, generate multiple values based on each of the sum value and the carry value, wherein the multiple values each correspond to a different respective layer of a normalization circuit, and wherein the LZA circuit generates the multiple values in parallel with a generation of the fourth significand value by the adder circuit; and
with the normalization circuit, perform a normalization of the fourth significand value based on the multiple values.

4. The processor of claim 3, wherein the first circuitry to execute the decoded FMA instruction comprises the first circuitry further to:
generate the aligned version of the third significand value, comprising the first circuitry perform a shift of the third significand value based on a difference between:
a first exponent value of the first operand, and
a second exponent value of the second operand.

5. The processor of claim 4, wherein the first circuitry is to generate the aligned version of the third significand value in parallel with a generation of the sum value and the carry value.

6. The processor of claim 3, wherein, based on the multiple values, the LZA circuit is to signal the normalization circuit to limit the normalization of the fourth significand value.

7. The processor of claim 3, wherein:
the normalization of the fourth significand value is to generate a fifth significand value; and
the first circuitry to execute the decoded FMA instruction comprises the first circuitry further to:
perform an evaluation, in parallel with the normalization, to detect a condition wherein the fifth significand value includes an indication of a two's complement representation;
provide a first value comprising a result of the evaluation;
generate a second value, based on the first value, which indicates whether the fifth significand value is to be rounded; and
round the fifth significand value with the second value to generate a sixth significand value.

8. The processor of claim 1, further comprising:
second circuitry to execute a floating point multiplication (FMUL) instruction with an adder circuit and a leading zero anticipator (LZA) circuit of the first circuitry.

9. The processor of claim 8, wherein:
the FMUL instruction comprises a third representation of a third multiplicand, and a fourth representation of a fourth multiplicand; and
the second circuitry to execute the FMUL instruction comprises the second circuitry to:
perform an evaluation to detect an instance of:
an occurrence of an underflow event; or
one of the third representation or the fourth representation being a denormal representation; and
perform, based on the evaluation, a selection of one of:
a first provisional result which is generated with the second circuitry; or
a second provisional result which is generated with the adder circuit and the LZA circuit of the first circuitry.

10. A method at a processor, the method comprising:
executing a fused multiply-add (FMA) instruction which comprises a first representation of a first multiplicand, and a second representation of a second multiplicand, wherein executing the FMA instruction comprises:
generating a selection value based on a first significand value of the first representation; and
generating a plurality of values which each correspond to a different respective multiple of a second significand value of the second representation;
detecting a condition wherein one of the first representation or the second representation is a normal representation, and wherein the other of the first representation or the second representation is a denormal representation;
based on the condition, providing to a multiplier array circuit one of the first significand value or the second significand value; and
with the multiplier array circuit, performing a selection from among the plurality of values based on the selection value, and further perform a subtraction with the one of the first significand value or the second significand value.

11. The method of claim 10, wherein:
the FMA instruction further comprises a third representation of an addend;
a sum value and a carry value is generated with the multiplier array circuit based on the first significand value, the second significand value, and a third significand value of the addend;
executing the FMA instruction further comprises:
providing both the sum value and the carry value to each of an adder circuit and a leading zero anticipator (LZA) circuit;
with the adder circuit, generating a fourth significand value based on each of the sum value, the carry value, and further based on an aligned version of the third significand value;
with the LZA circuit, generating multiple values based on each of the sum value and the carry value, wherein the multiple values each correspond to a different respective layer of a normalization circuit, and wherein the LZA circuit generates the multiple values in parallel with a generation of the fourth significand value by the adder circuit; and
with the normalization circuit, performing a normalization of the fourth significand value based on the multiple values.

12. The method of claim 11, wherein executing the FMA instruction further comprises:
generating the aligned version of the third significand value, comprising the first circuitry perform a shift of the third significand value based on a difference between:
a first exponent value of the first operand, and
a second exponent value of the second operand.

13. The method of claim 11, wherein, based on the multiple values, the LZA circuit signals the normalization circuit to limit the normalization of the fourth significand value.

14. The method of claim 11, wherein:
the normalization of the fourth significand value generates a fifth significand value; and
executing the FMA instruction further comprises:
performing an evaluation, in parallel with the normalization, to detect a condition wherein the fifth significand value includes an indication of a two's complement representation;
providing a first value comprising a result of the evaluation;
generating a second value, based on the first value, which indicates whether the fifth significand value is to be rounded; and
rounding the fifth significand value with the second value to generate a sixth significand value.

15. The method of claim 10, further comprising:
executing a floating point multiplication (FMUL) instruction with an adder circuit and a leading zero anticipator (LZA) circuit.

16. A system comprising:
a memory to store a fused multiply-add (FMA) instruction which comprises a first representation of a first multiplicand, and a second representation of a second multiplicand;
a processor coupled to the memory, the processor comprising:
decoder circuitry to decode a fused multiply-add (FMA) instruction to generate a decoded FMA instruction which comprises a first representation of a first multiplicand, and a second representation of a second multiplicand; and
first circuitry coupled to the decoder circuitry, the first circuitry to execute the decoded FMA instruction, comprising the first circuitry to:
generate a selection value based on a first significand value of the first representation; and
generate a plurality of values which each correspond to a different respective multiple of a second significand value of the second representation;
detect a condition wherein one of the first representation or the second representation is a normal representation, and wherein the other of the first representation or the second representation is a denormal representation;
based on the condition, provide to a multiplier array circuit one of the first significand value or the second significand value; and
with the multiplier array circuit, perform a selection from among the plurality of values based on the selection value, and further perform a subtraction with the one of the first significand value or the second significand value.

17. The system of claim 16, wherein:
the decoded FMA instruction further comprises a third representation of an addend;
a sum value and a carry value is to be generated with the multiplier array circuit based on the first significand value, the second significand value, and a third significand value of the addend;
the first circuitry to execute the decoded FMA instruction comprises the first circuitry further to:
provide both the sum value and the carry value to each of an adder circuit and a leading zero anticipator (LZA) circuit;
with the adder circuit, generate a fourth significand value based on each of the sum value, the carry value, and further based on an aligned version of the third significand value;
with the LZA circuit, generate multiple values based on each of the sum value and the carry value, wherein the multiple values each correspond to a different respective layer of a normalization circuit, and wherein the LZA circuit generates the multiple values in parallel with a generation of the fourth significand value by the adder circuit; and
with the normalization circuit, perform a normalization of the fourth significand value based on the multiple values.

18. The system of claim 17, wherein, based on the multiple values, the LZA circuit is to signal the normalization circuit to limit the normalization of the fourth significand value.

19. The system of claim 17, wherein:
the normalization of the fourth significand value is to generate a fifth significand value; and
the first circuitry to execute the decoded FMA instruction comprises the first circuitry further to:
perform an evaluation, in parallel with the normalization, to detect a condition wherein the fifth significand value includes an indication of a two's complement representation;
provide a first value comprising a result of the evaluation;
generate a second value, based on the first value, which indicates whether the fifth significand value is to be rounded; and
round the fifth significand value with the second value to generate a sixth significand value.

20. The system of claim 16, the processor further comprising:
second circuitry to execute a floating point multiplication (FMUL) instruction with an adder circuit and a leading zero anticipator (LZA) circuit of the first circuitry.
